(19) United States
(12) Patent Application Publication
(10) Pub. No.: US 2025/0088584 A1
(43) Pub. Date: Mar. 13, 2025

(54) USER INTERFACES FOR TRACKING AND GENERATING ALERTS ON ELECTRONIC DEVICES

(71) Applicant: Apple Inc., Cupertino, CA (US)

(72) Inventors: Frank DE JONG, San Francisco, CA (US); Tyler D. HAWKINS, San Jose, CA (US); David S. WILSER, San Jose, CA (US); Benjamin A. WERNER, San Jose, CA (US); Richard B. ONG, San Francisco, CA (US); Andrey LIFINSKIY, Los Angeles, CA (US); Andrez E. AGUAYO, Campbell, CA (US); Benjamin T. CHRISTIE, Santa Barbara, CA (US); Anton M. DAVYDOV, Gilroy, CA (US); Marcello LUPPI, London (GB); Yibo ZHU, San Jose, CA (US); Travis JONES, Hickory Creek, TX (US); Taylor G. CARRIGAN, San Francisco, CA (US); Jules K. FENNIS, Seattle, WA (US); Pedro MARI, Santa Cruz, CA (US); Charles C. HOYT, Pacifica, CA (US); Molly P. WIEBE, San Francisco, CA (US); Gary I. BUTCHER, Los Gatos, CA (US)

(21) Appl. No.: 18/830,509

(22) Filed: Sep. 10, 2024

Related U.S. Application Data
(60) Provisional application No. 63/581,933, filed on Sep. 11, 2023.

(51) Int. Cl. H04M 1/72457; G06F 3/01; H04M 1/72409

(52) U.S. Cl. CPC H04M 1/72457; G06F 3/016; H04M 1/72409

(57) ABSTRACT

In some embodiments, a first electronic device facilitates tracking of a second electronic device. In some embodiments, when the first electronic device and the second electronic device are within a specified distance from each other, the second electronic device automatically generates an alert to indicate its current location. In some embodiments, the alert includes audio and/or tactical feedback.

### CROSS-REFERENCE TO RELATED APPLICATIONS

This application claims the benefit of U.S. Provisional Application No. 63/581,933, filed Sep. 11, 2023, the content of which is herein incorporated by reference in its entirety for all purposes.

### FIELD OF THE DISCLOSURE

This disclosure relates generally to an electronic device presenting user interfaces for tracking and generating alerts on electronic devices.

### BACKGROUND OF THE DISCLOSURE

User interaction with electronic devices has increased significantly in recent years. These devices can be devices such as computers, tablet computers, televisions, multimedia devices, or mobile devices. In some circumstances, users may wish to use such devices to track other devices. The user may therefore desire efficient ways of tracking electronic devices for locating the electronic devices.

### SUMMARY OF THE DISCLOSURE

Providing efficient ways of tracking electronic devices using automatic alerts and distance and directional information improves the user's experience with the electronic device by reducing the length of the locating process and thus saving power and/or other computing resources of the electronic devices

In some embodiments, a first electronic device facilitates tracking of a second electronic device. In some embodiments, when the first electronic device and the second electronic device are within a specified distance from each other, the second electronic device automatically generates an alert to indicate its current location. The full descriptions of the embodiments are provided in the Drawings and the Detailed Description, and it is understood that the Summary provided above does not limit the scope of the disclosure in any way.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIGS. 3A-3G is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 6A-6O illustrate exemplary ways in which a first electronic device and a second electronic device interact with each other during a finding process in accordance with some embodiments of the disclosure.

FIG. 7 illustrates a flow diagram illustrating a method in which a first electronic device and a second electronic device interact with each other during a finding process in accordance with some embodiments of the disclosure.

### DETAILED DESCRIPTION

In the following description of embodiments, reference is made to the accompanying drawings which form a part hereof, and in which it is shown by way of illustration specific embodiments that are optionally practiced. It is to be understood that other embodiments are optionally used and structural changes are optionally made without departing from the scope of the disclosed embodiments.

Providing efficient ways of tracking electronic devices using automatic alerts and distance and directional information improves the user's experience with the electronic device by reducing the length of the locating process and thus saving power and/or other computing resources of the electronic devices. In some embodiments, a first electronic device facilitates tracking of a second electronic device. In some embodiments, when the first electronic device and the second electronic device are within a specified distance from each other, the second electronic device automatically generates an alert to indicate its current location.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

### Exemplary Devices

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touch pads), are, optionally, used. It should also be understood that, in some embodiments, the device is not a portable communications device, but is a desktop computer or a television with a touch-sensitive surface (e.g., a touch screen display and/or a touch pad). In some embodiments, the device does not have a touch screen display and/or a touch pad, but rather is capable of outputting display information (such as the user interfaces of the disclosure) for display on a separate display device, and capable of receiving input information from a separate input device having one or more input mechanisms (such as one or more buttons, a touch screen display and/or a touch pad). In some embodiments, the device has a display, but is capable of receiving input information from a separate input device having one or more input mechanisms (such as one or more buttons, a touch screen display and/or a touch pad). In some embodiments, the electronic device is a computer system that is in communication (e.g., via wireless communication, via wired communication) with a display generation component (e.g., a display device such as a head-mounted device (HMD), a display, a projector, a touch-sensitive display, or other device or component that presents visual content to a user, for example, on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse and/or a joystick. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

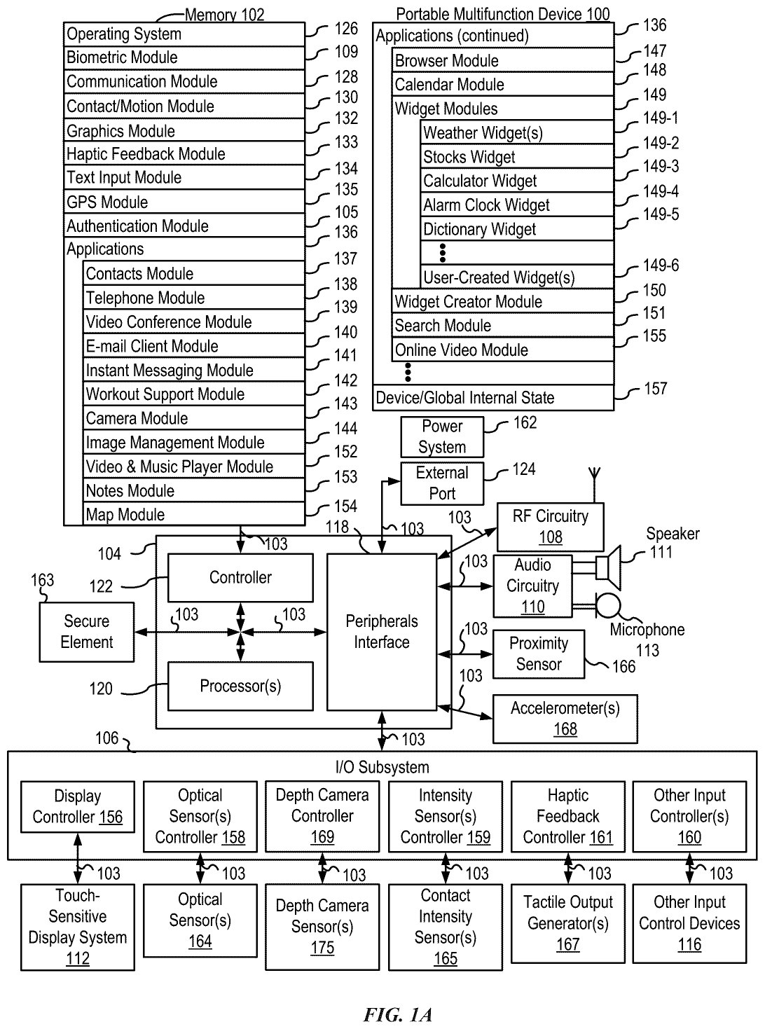

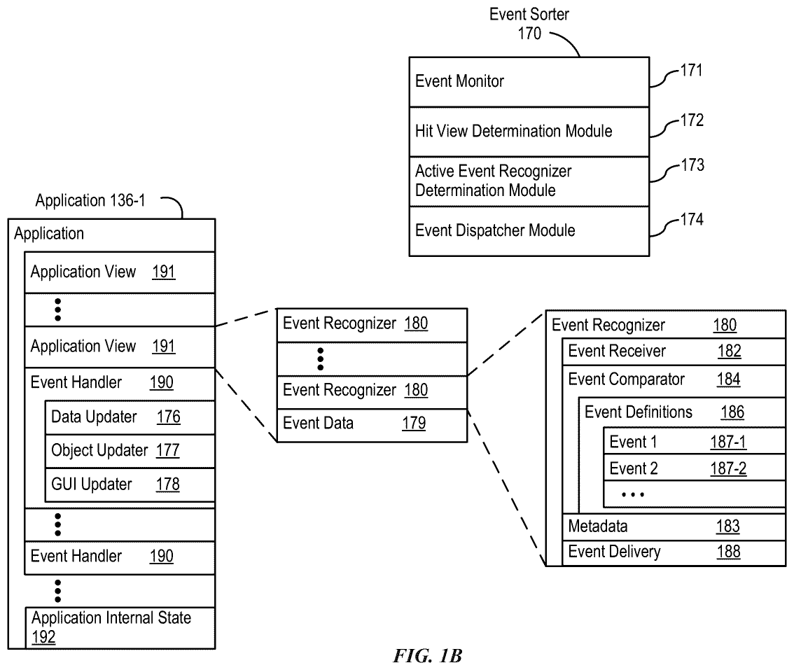

Attention is now directed toward embodiments of portable or non-portable devices with touch-sensitive displays, though the devices need not include touch-sensitive displays or displays in general, as described above. FIG. 1A is a block diagram illustrating portable or non-portable multifunction device 100 with touch-sensitive displays 112 in accordance with some embodiments. Touch-sensitive display 112 is sometimes called a “touch screen” for convenience, and is sometimes known as or called a touch-sensitive display system. Device 100 includes memory 102 (which optionally includes one or more computer readable storage mediums), memory controller 122, one or more processing units (CPU's) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as a “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable or non-portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application specific integrated circuits. Further, the various components shown in FIG. 1A are optionally implemented across two or more devices; for example, a display and audio circuitry on a display device, a touch-sensitive surface on an input device, and remaining components on device 100. In such an embodiment, device 100 optionally communicates with the display device and/or the input device to facilitate operation of the system, as described in the disclosure, and the various components described herein that relate to display and/or input remain in device 100, or are optionally included in the display and/or input device, as appropriate.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data.

In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

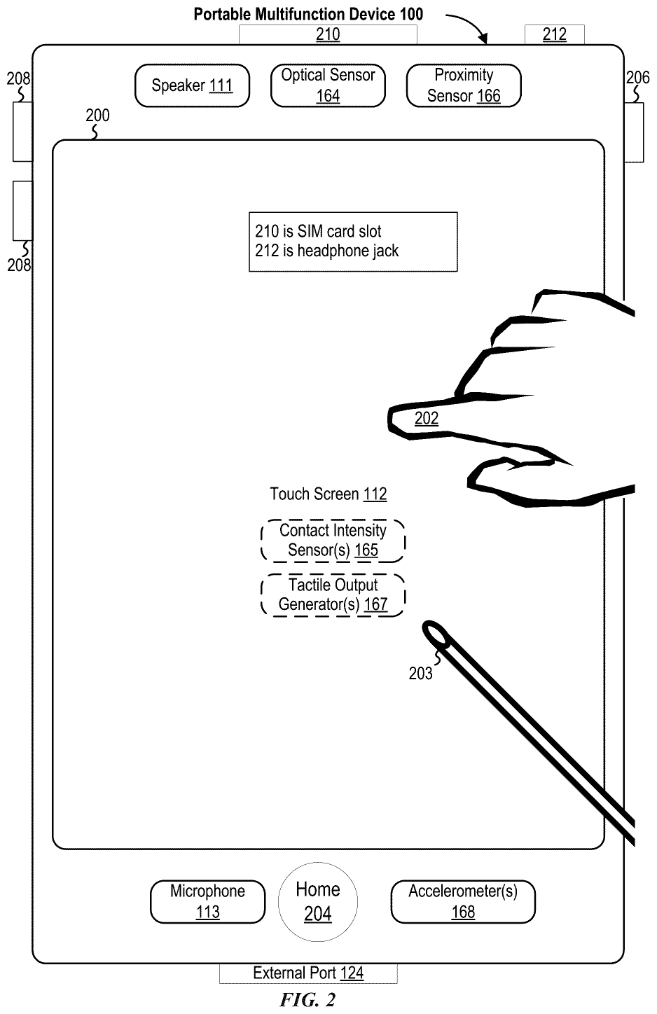

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161 and one or more input controllers 160 for other input or control devices. The one or more input controllers 160 receive/send electrical signals from/to other input or control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, infrared port, USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. As described above, the touch-sensitive operation and the display operation of touch-sensitive display 112 are optionally separated from each other, such that a display device is used for display purposes and a touch-sensitive surface (whether display or not) is used for input detection purposes, and the described components and functions are modified accordingly. However, for simplicity, the following description is provided with reference to a touch-sensitive display. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output corresponds to user-interface objects.

Touch screen 112 has a touch-sensitive surface, sensor or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone®, iPod Touch®, and iPad® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable or non-portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112 which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112 which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

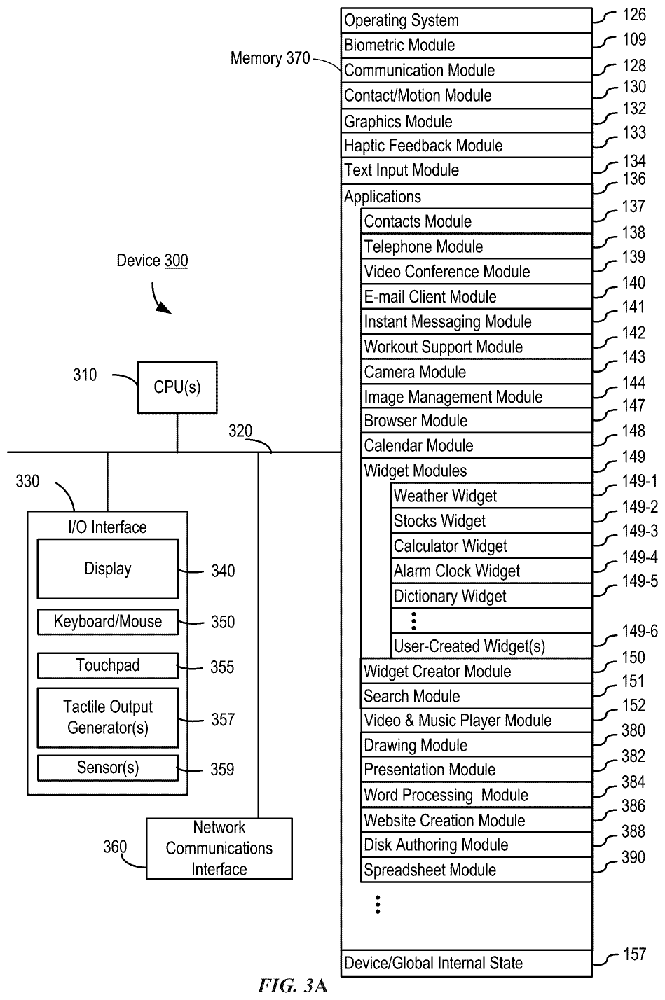

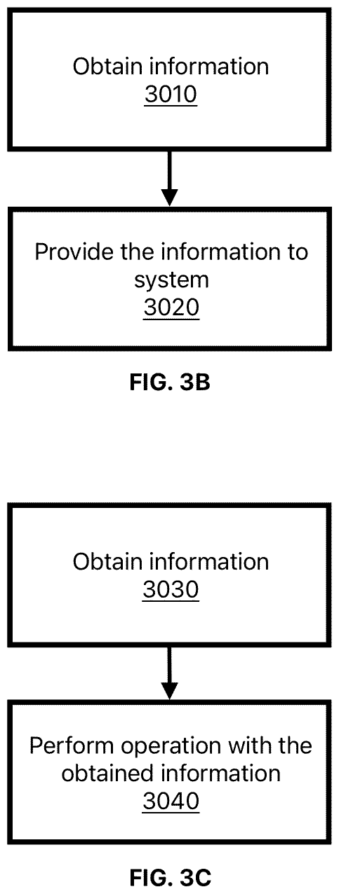

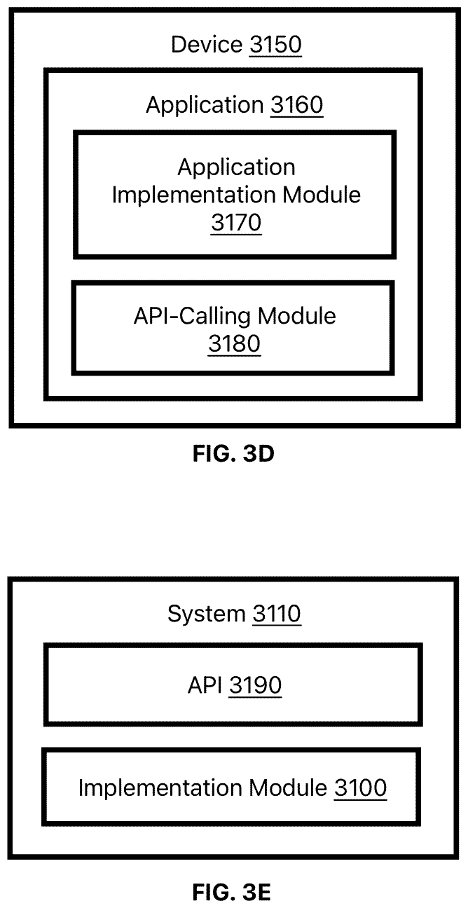

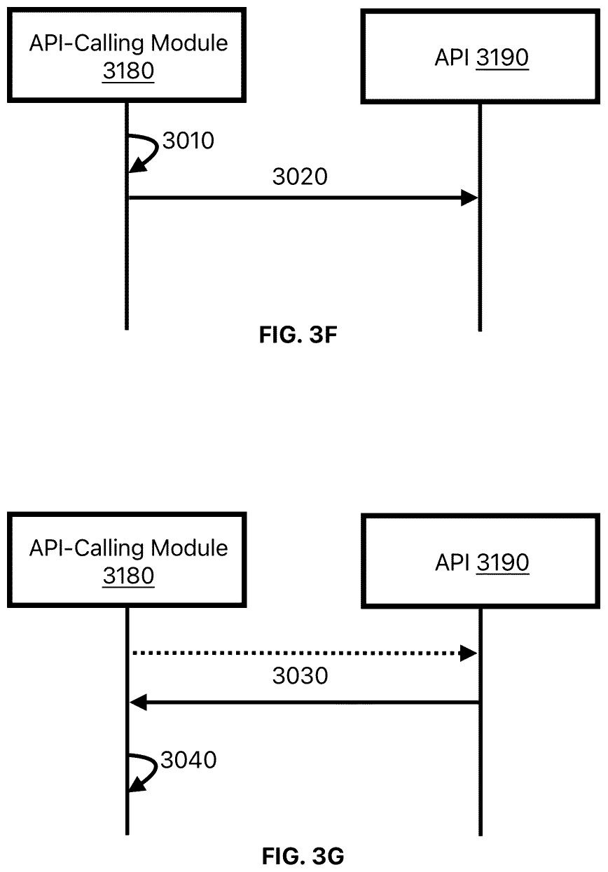

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3A) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact) determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
video player module;
music player module;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which merges video player module and music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo!Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable or non-portable multifunction device 100 having a touch screen 112 in accordance with some embodiments. As stated above, multifunction device 100 is described as having the various illustrated structures (such as touch screen 112, speaker 111, accelerometer 168, microphone 113, etc.); however, it is understood that these structures optionally reside on separate devices. For example, display-related structures (e.g., display, speaker, etc.) and/or functions optionally reside on a separate display device, input-related structures (e.g., touch-sensitive surface, microphone, accelerometer, etc.) and/or functions optionally reside on a separate input device, and remaining structures and/or functions optionally reside on multifunction device 100.

The touch screen 112 optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As previously described, menu button 204 is, optionally, used to navigate to any application 136 in a set of applications that are, optionally executed on device 100. Alternatively, in some embodiments, the menu button is implemented as a soft key in a GUI displayed on touch screen 112.

In one embodiment, device 100 includes touch screen 112, menu button 204, push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not include the display and the touch-sensitive surface, as described above, but rather, in some embodiments, optionally communicates with the display and the touch-sensitive surface on other devices. Additionally, device 300 need not be portable. In some embodiments, device 300 is a laptop computer, a desktop computer, a tablet computer, a multimedia player device (such as a television or a set-top box), a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable or non-portable multifunction device 100 (FIG. 1A), or a subset thereof. Furthermore, memory 370 optionally stores additional programs, modules, and data structures not present in memory 102 of portable or non-portable multifunction device 100. For example, memory 370 of device 300 optionally stores drawing module 380, presentation module 382, word processing module 384, website creation module 386, disk authoring module 388, and/or spreadsheet module 390, while memory 102 of portable or non-portable multifunction device 100 (FIG. 1A) optionally does not store these modules.

Each of the above identified elements in FIG. 3A are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

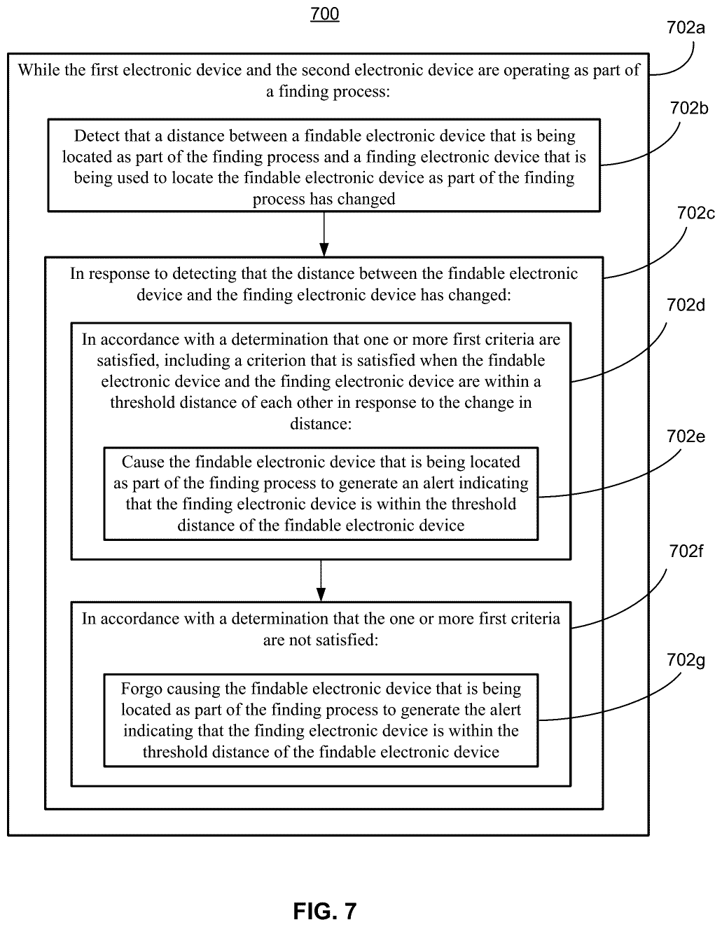

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 700 (FIG. 7) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

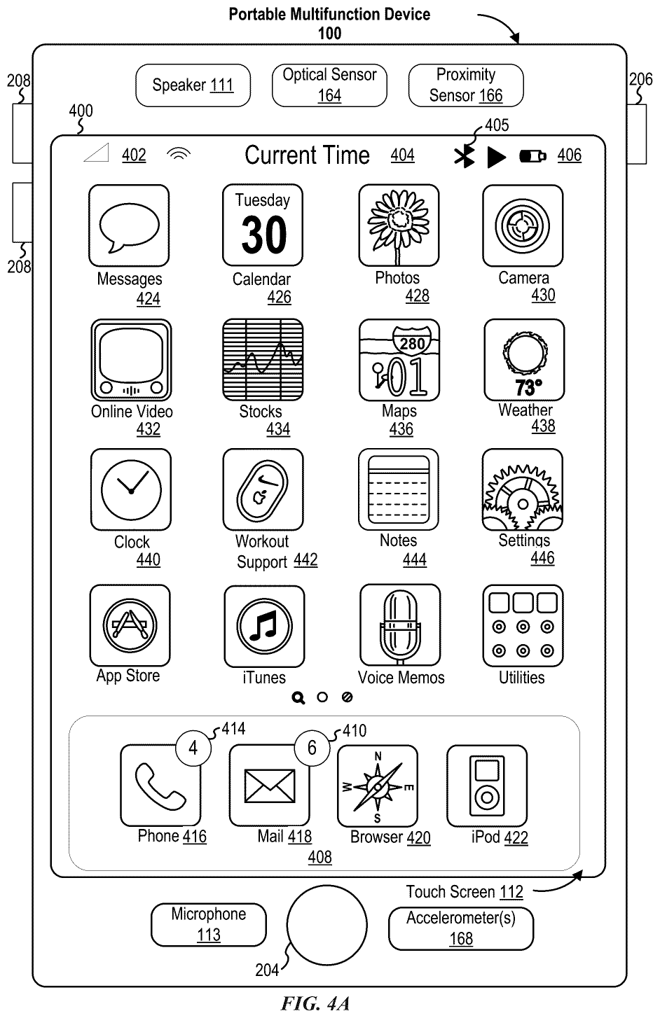

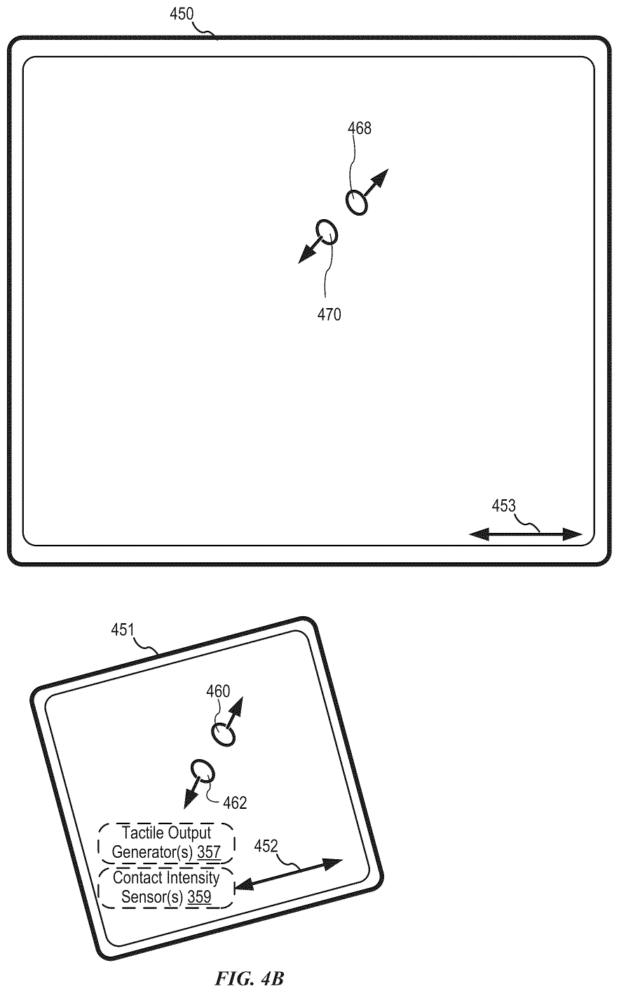

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90% or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the description of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

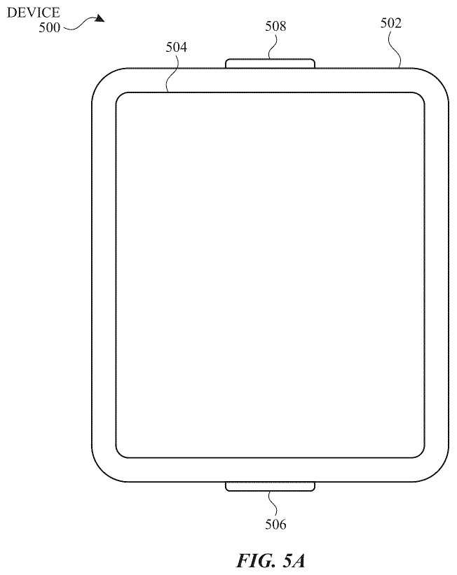

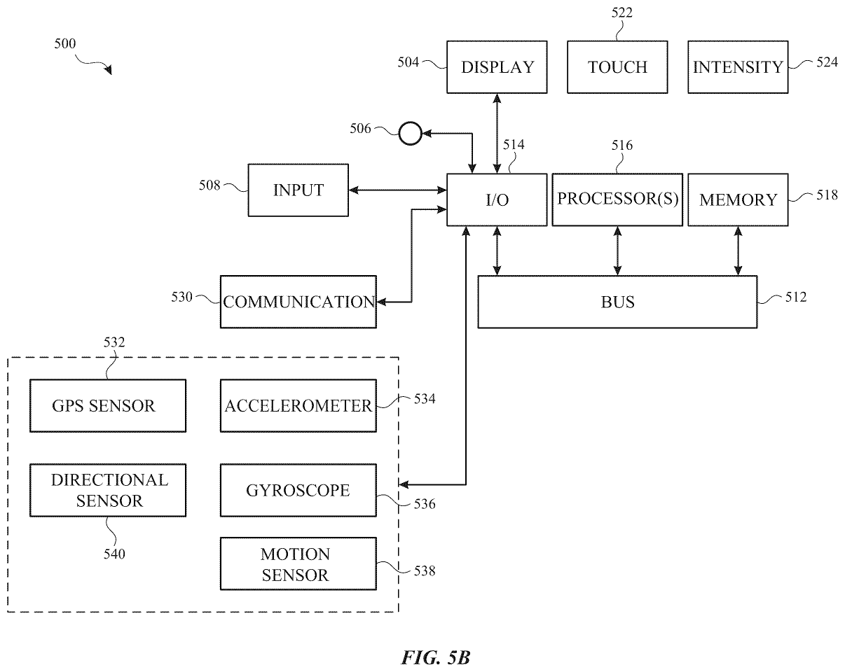

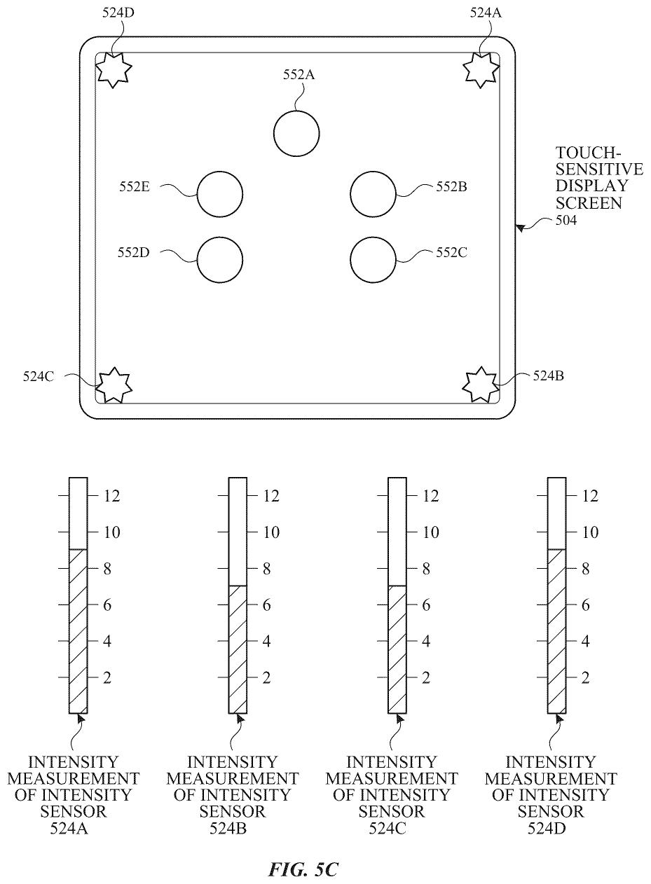

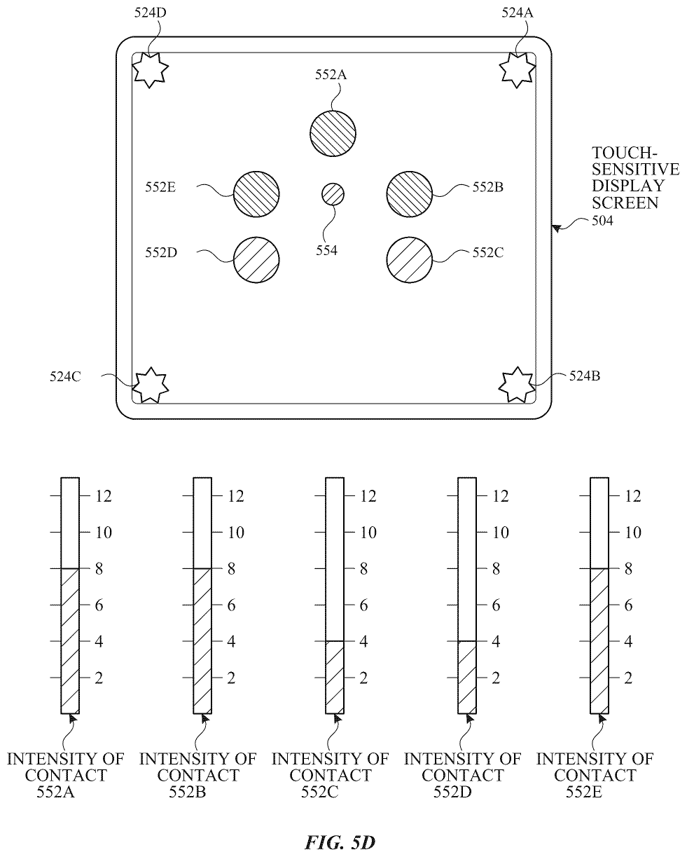

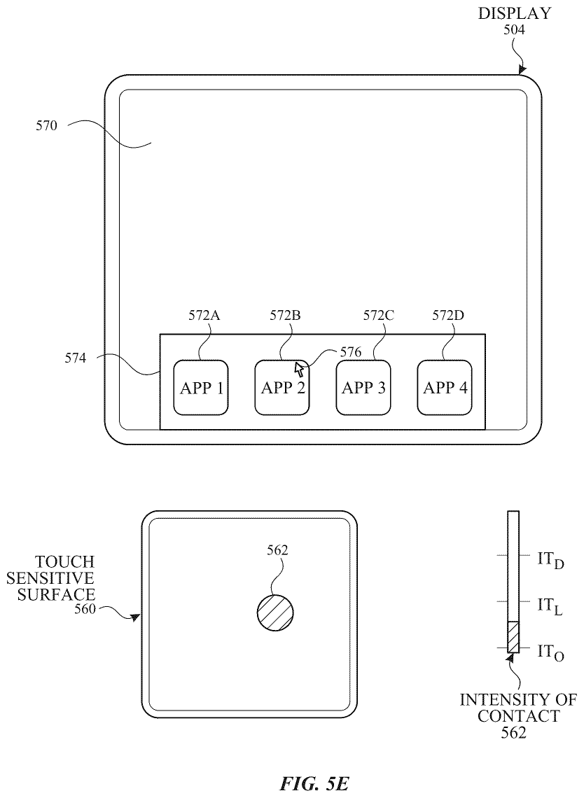

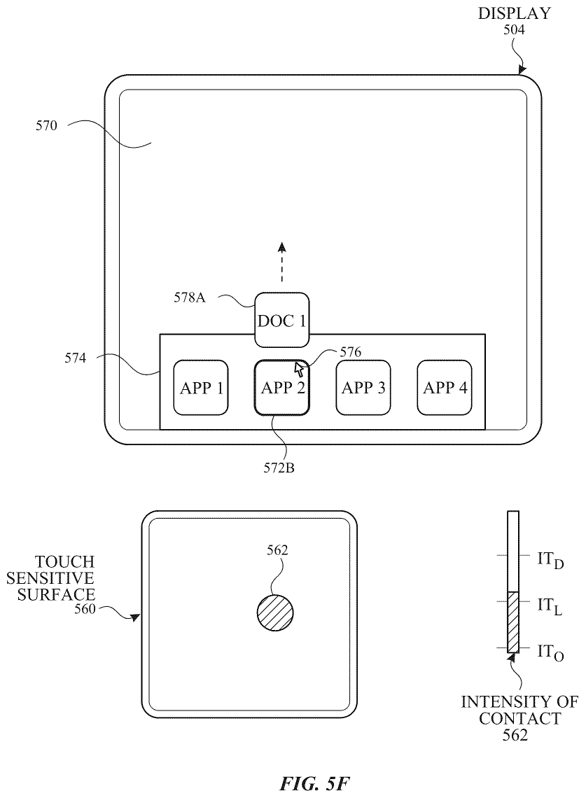

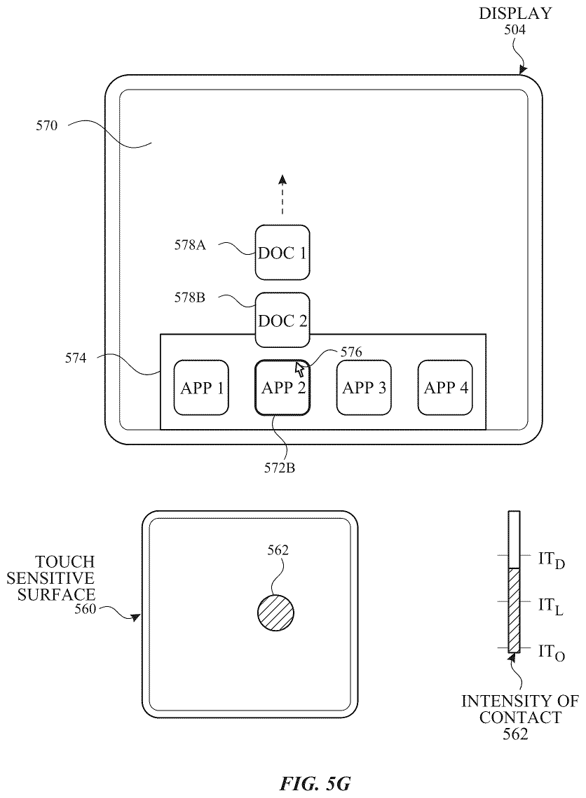

FIG. 5A illustrates a block diagram of an exemplary architecture for the device 500 according to some embodiments of the disclosure. In the embodiment of FIG. 5A, media or other content is optionally received by device 500 via network interface 502, which is optionally a wireless or wired connection. The one or more processors 504 optionally execute any number of programs stored in memory 506 or storage, which optionally includes instructions to perform one or more of the methods and/or processes described herein (e.g., method 700). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIGS. 5, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D}”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D}”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D}”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as device 100, device 300, or device 500.

### User Interfaces and Associated Processes

### Interactions During a Finding Process

Users interact with electronic devices in many different manners. In some embodiments, a first electronic device is in communication with one or more input devices, a display generation component, and wireless circuitry. In some embodiments, the first electronic device is in communication with a second electronic device that is also in communication with one or more input devices, a display generation component, and wireless circuitry. In some embodiments, the first electronic device and the second electronic device are operating in a finding process where one device is used to find the other device. In some embodiments, the device initiating the finding process is the finding electronic device and the device being located is the findable electronic device. In some embodiments, the finding electronic device displays a finding user interface which visually assists a user in locating the findable electronic device. As described herein, the first electronic device is the finding electronic device and the second electronic device is the findable electronic device. However, in some embodiments, the first electronic device is the findable electronic device, and the second electronic device is the finding electronic device. The embodiments described below provide ways in which the finding electronic device displays a series of user interfaces to facilitate locating of the findable electronic device. The embodiments described below also provide ways in which the findable electronic device generates an alert to indicate that the finding electronic device is within a threshold distance from the findable electronic device. Automatically generating an alert on the findable electronic device when the first electronic device and the second electronic device are within the threshold distance from each other allows a user of the finding device and/or the findable electronic device to efficiently locate the findable electronic device, thus reducing the length of the locating process and saving power and/or other computing resources of the first and/or second electronic devices. It is understood that people use devices. When a person uses a device, that person is optionally referred to as a user of the device.

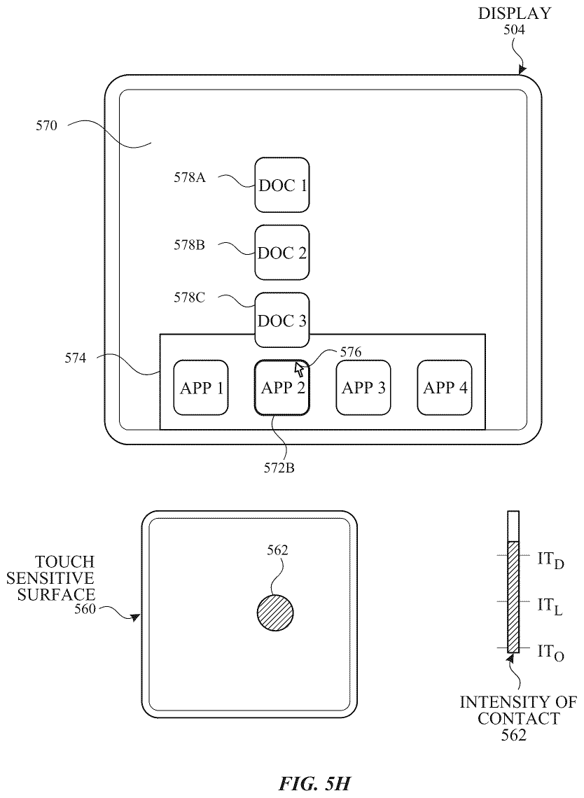

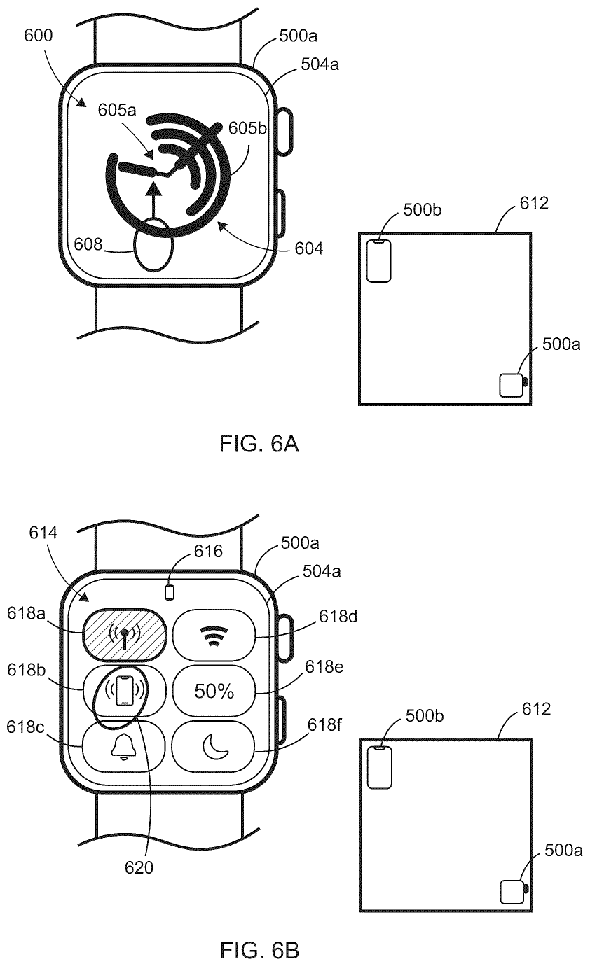

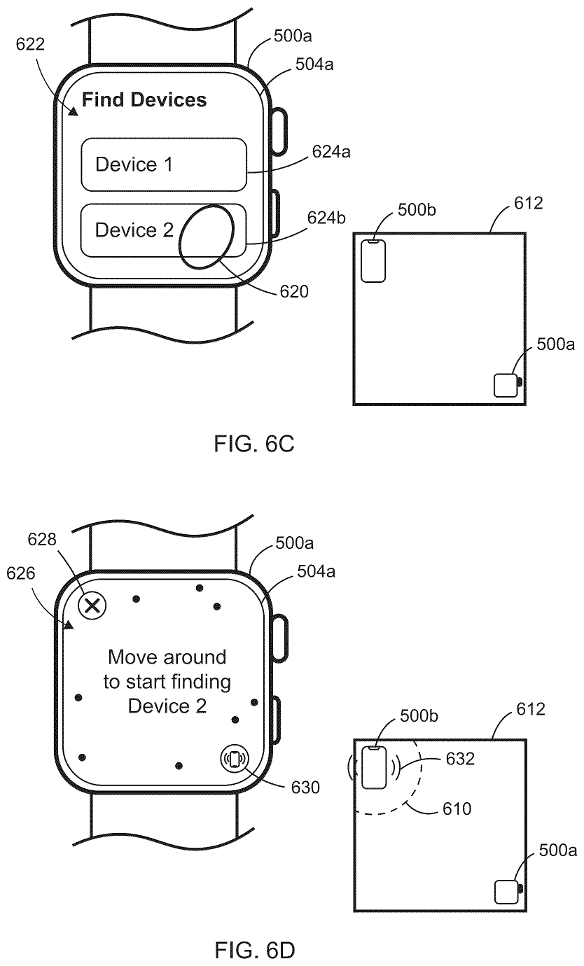

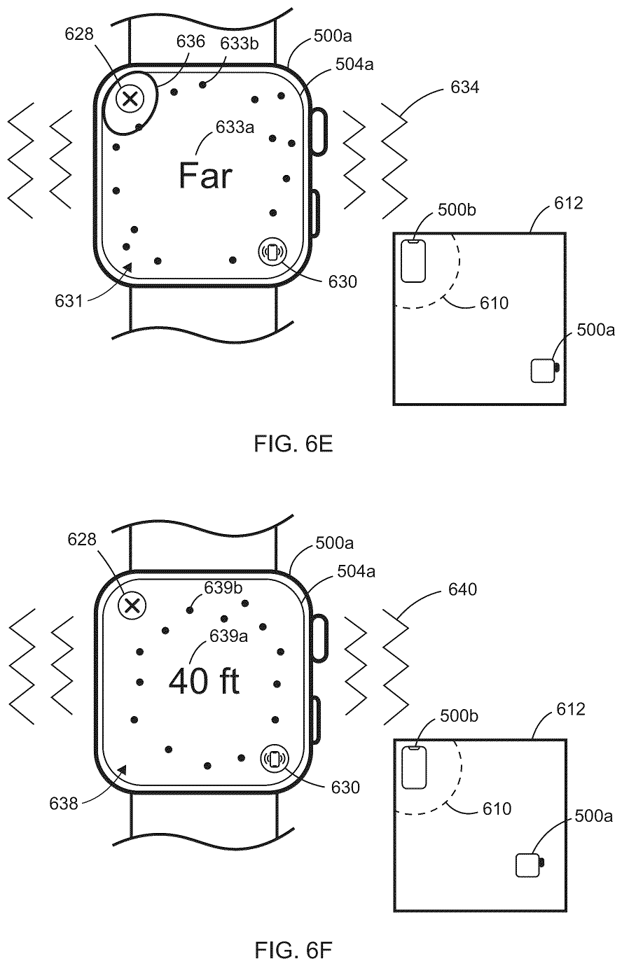

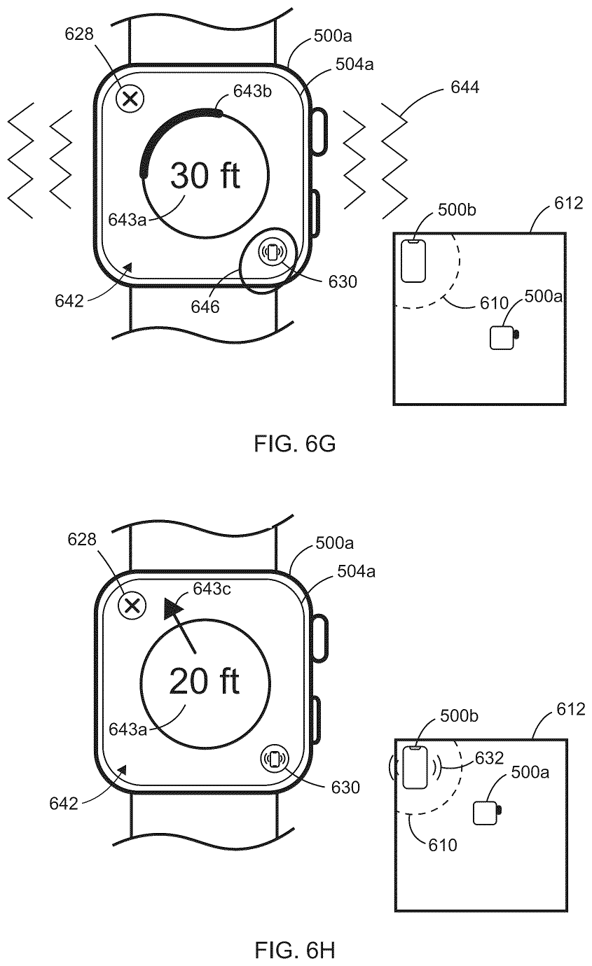

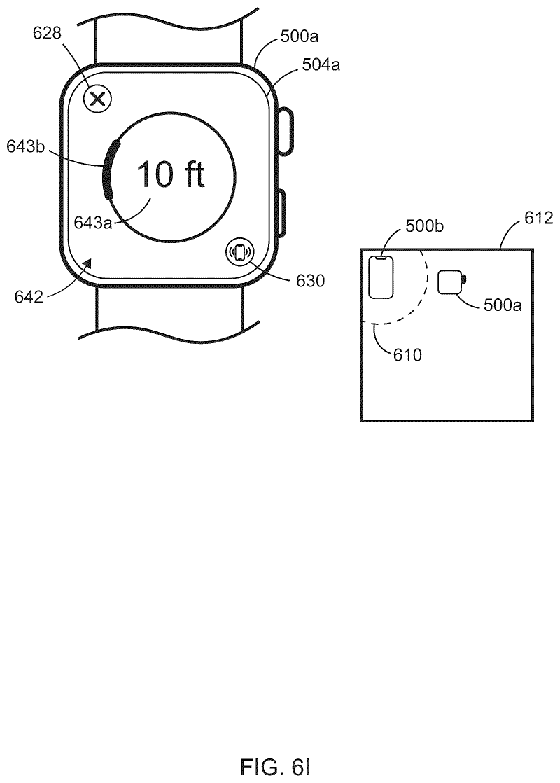

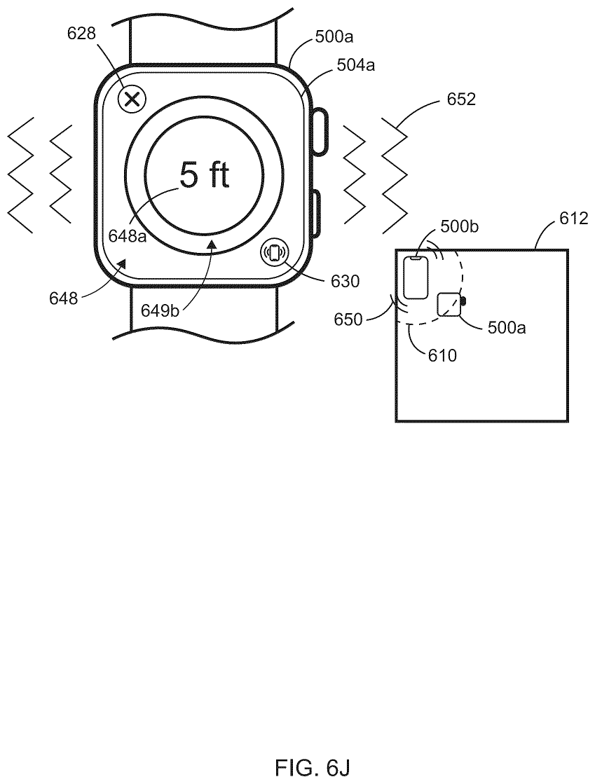

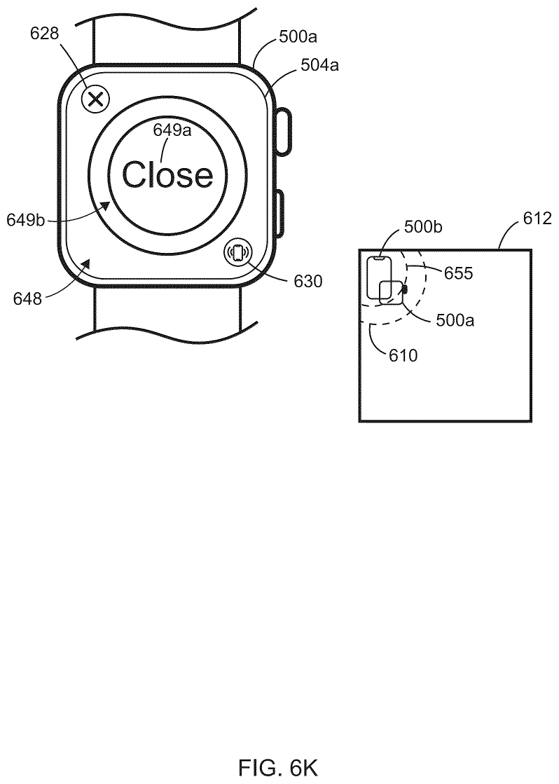

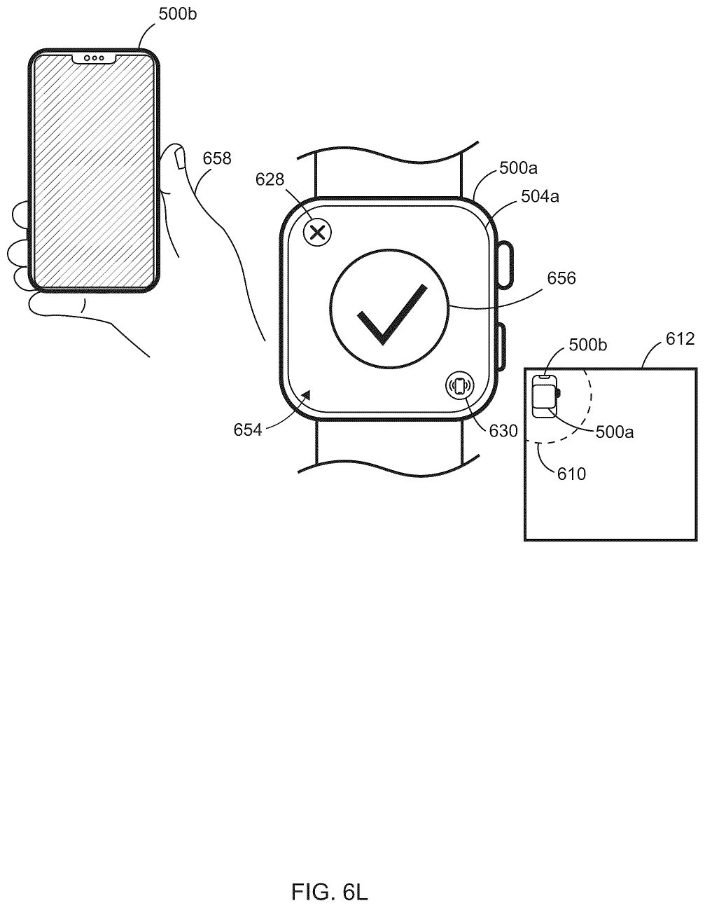

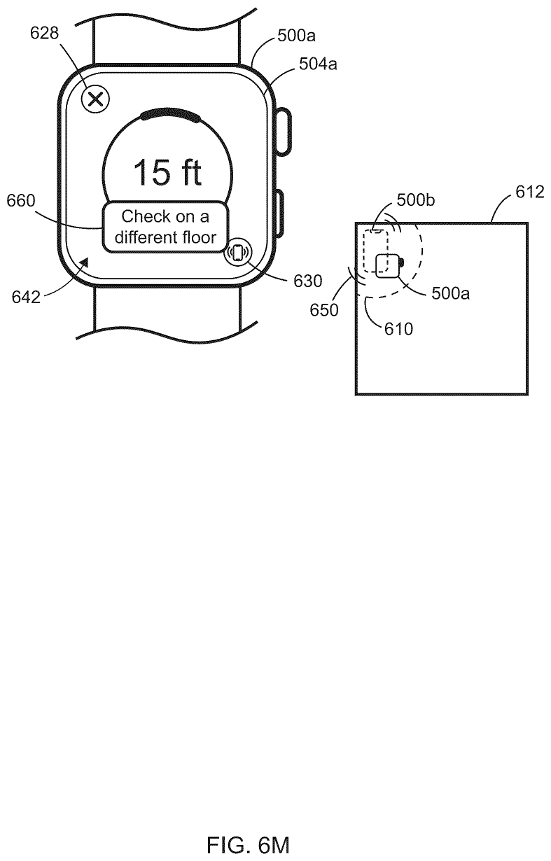

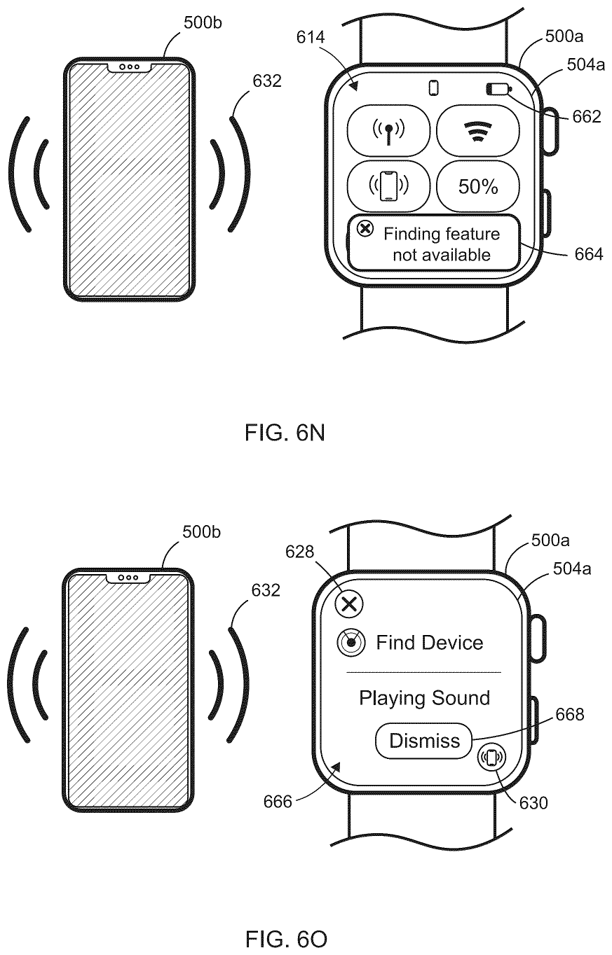

FIGS. 6A-6O illustrate exemplary ways in which a first electronic device and a second electronic device interact with each other during a finding process. FIGS. 6A-6O also include a top-down view of an environment (e.g., a physical environment) in which the first electronic device and the second electronic device reside in. As discussed below, the first electronic device and the second electronic device are optionally located in the same environment, though it should be understood that, in some embodiments, the first electronic device and the second electronic device are located in different environments. The embodiments in these figures are used to illustrate the processes described below, including the processes described with reference to FIG. 7. Although FIGS. 6A-6O illustrate various examples of ways an electronic device is able to perform the processes described below with respect to FIG. 7, it should be understood that these examples are not meant to be limiting, and the electronic device is able to perform one or more processes described below with reference to FIG. 7 in ways not expressly described with reference to FIGS. 6A-6O.

FIG. 6A illustrates a first electronic device 500a with a first display generation component 504a (e.g., a touchscreen). In some embodiments, the first electronic device 500a is a mobile device, such as a smartphone, tablet, or wearable device. In some embodiments, the first electronic device 500a is in communication with a second electronic device 500b (e.g., a companion device such as a phone, tablet, computer or other electronic devices as described herein). In some embodiments, the second electronic device 500b and the first electronic device 500a are associated with a same user account and/or are wirelessly connected to each other (e.g., by Bluetooth, WiFi, or other wireless connections), as described in further detail in method 700. In some embodiments, the first electronic device 500a and the second electronic device 500b are co-located in an environment 612. For example, the first electronic device 500a and the second electronic device 500b are located in a house (e.g., in separate rooms or in the same room). In some embodiments, the first electronic device 500a and the second electronic device 500b are located in different locations (e.g., at different addresses).

In some embodiments, the first electronic device 500a includes a home screen user interface 600 displayed on the first display generation component 504a. In some embodiments, the home screen user interface 600 includes widgets that display information from various applications. For example, as shown in FIG. 6A, the home screen user interface 600 includes a widget 604 of a clock application and an activity application. In some embodiments, widget 604 shows a visual representation 605a of the time as well as a visual representation 605b of the amount of activity a user of the first electronic device 500a has participated in. In some embodiments, the home screen user interface 600 receives data from the clock application and the activity application to be used in the display of widget 604.

In some embodiments, the first electronic device 500a detects a swipe input from the user on the first display generation component 504a (e.g., movement of contact 608 corresponding to a swipe up on the home screen user interface 600). In response to receiving the swipe input, the first electronic device 500a displays a control user interface 614, as shown in FIG. 6B. In some embodiments, the control user interface 614 is a system user interface, as described in method 700.

In some embodiments, the control user interface 614 includes a plurality of icons/selectable options that provide information about and/or access to various features on the first electronic device 500a. In some embodiments, the features are commonly used features. In some embodiments, the icons/selectable options are associated with a plurality of applications. As shown in FIG. 6B, the first electronic device 500a displays icon 616 on control user interface 614. Icon 616 indicates that the first electronic device 500a is in communication with the second electronic device 500b. For example, the first electronic device 500a is within the communication range of the second electronic device 500b (e.g., within the range of the Wi-Fi connection, Bluetooth connection, and/or other wireless connection). In FIG. 6B, the first electronic device 500a also displays a plurality of selectable options 618a-618f that are selectable to change corresponding settings of the first electronic device 500a. In FIG. 6B, selectable option 618a is selected and the first electronic device 500a indicates that selectable options 618a is selected by highlighting the icon. In some embodiments, selectable option 618a is selectable to turn on/off cellular data. In some embodiments, selectable option 618b is selectable to access the finding user interface, as described below, and to begin a finding process to find the second electronic device 500b. In some embodiments, selectable option 618c is selectable to turn on/off silent mode such that generating alerts (e.g., notifications) does not including outputting audio. In some embodiments, selectable option 618d is selectable to connect/disconnect the first electronic device 500a from known Wi-Fi networks. In some embodiments, selectable option 618e indicates a current battery percentage of the first electronic device 500a. In some embodiments, selectable option 618f is selectable to turn on/off a specified focus mode. In some embodiments, a user programs a focus mode which determines for which applications the first electronic device 500a generates alerts. In some embodiments, a user of the first electronic device 500a and/or the second electronic device 500b chooses which selectable options/icons are presented in the control user interface 614.

In some embodiments, the first electronic device 500a detects an input directed towards selectable option 618b, such as with contact 620, as shown in FIG. 6B. In some embodiments, the input is a tap input such as with a finger or a stylus detected on the first display generation component 504a. In some embodiments, in response to receiving the input, the first electronic device 500a displays a first finding user interface 626, as shown in FIG. 6D, of a series of finding user interfaces to be used during the finding process to find the second electronic device 500b.

FIG. 6C illustrates an embodiment of a user interface 622 of an item locating application. In some embodiments, the item locating application is an application that enables the user to track one or more devices that are in communication with the first electronic device 500a and/or the second electronic device 500b. In some embodiments, the user interface 622 includes one or more indications of one or more devices that are in communication with the first electronic device 500a that are able be found using the finding process, as described in method 700. In FIG. 6C, the user interface 622 includes selectable options 624a-624b, which represent the devices in communication with the first electronic device 500a and/or the second electronic device 500b. In some embodiments, the selectable options 624a and 624b represent devices (e.g., Device 1 and Device 2) that can be located using the finding process.

In some embodiments, as similarly described with reference to FIG. 6B, the first electronic device 500a detects an input directed towards selectable option 624b via a tap of contact 620. In response to receiving the input, the first electronic device 500a begins the finding process with the second electronic device 500b. In some embodiments, as similarly discussed above, in response to receiving the input, the first electronic device 500a displays the first finding user interface 626, as shown in FIG. 6D, of a series of finding user interfaces to be used during the finding process to find the second electronic device 500b. In some embodiments, in response to receiving the input, the first electronic device 500a also transmits a request to the second electronic device 500b to generate a locating alert 632, as shown in FIG. 6D. In some embodiments, the locating alert 632 is a manually generated alert (e.g., generated in response to an input on the first electronic device 500a) including visual, audio, and/or tactile feedback to help physically assist a user in navigating to the location of the second electronic device 500b. In some embodiments, the locating alert 632 is described in further detail in method 700.

FIG. 6D illustrates the first finding user interface 626 of the finding process. In some embodiments, the first electronic device 500a displays the first finding user interface 626 when the first electronic device 500a does not have directional and distance information of the second electronic device 500b. In some embodiments, while displaying the first finding user interface 626, the first electronic device 500a and/or the second electronic device 500b have not received a finding signal (e.g., such as with ultra-bandwidth wireless transmission), as described in method 700. As a result, no distance and/or directional information is optionally displayed on the first finding user interface 626, as shown in FIG. 6D. In some embodiments, the finding user interfaces (e.g., including the first finding user interface 626) described in FIGS. 6D-6K include selectable options 628 and 630. In some embodiments, in response to receiving an input directed towards selectable option 628, the first electronic device 500a ends the finding process and ceases to display the finding user interface currently displayed (e.g., first finding user interface 626 in FIG. 6D). In some embodiments, in response to receiving an input directed towards selectable option 630, the first electronic device 500a transmits a request to the second electronic device 500b to generate the locating alert 632 discussed above.

In some embodiments, operating the finding process includes operating relative to a threshold distance 610 around the second electronic device 500b (e.g., the device being located), as described in greater detail in method 700. In some embodiments, if the first electronic device 500a (e.g., the locating device) enters the threshold distance 610, then the second electronic device 500b generates an alert (e.g., different from the locating alert 632), as described in method 700 and in more detail with reference to FIG. 6J.

In some embodiments, the first electronic device 500a moves locations, as shown in the top-down environment 612 in FIG. 6E. For example, the first electronic device 500a is moved by a user. In response to the movement of the first electronic device 500a, the finding process changes states from a no finding signal state to a finding signal with no distance information state and/or directional information, which is described in further detail in method 700. As a result, the first electronic device 500a ceases to display the first finding user interface 626 associated with the no finding signal state and begins displaying the second finding user interface 631, shown in FIG. 6E. Additionally, in response to transitioning finding signal states (and user interfaces), the first electronic device 500a optionally generates an alert 634, described in further detail in method 700. In some embodiments, the alert 634 includes tactile, audio, and/or visual feedback indicating that the finding process has transitioned finding states. In some embodiments, the alert 634 is different than the locating alert 632 generated at the second electronic device 500b.

As shown in FIG. 6E, the second finding user interface 631 includes a visual indication describing the distance to the second electronic device 500b. Because the first electronic device 500a only has a finding signal without distance information, the first electronic device 500a displays visual indication 633a indicating that the second electronic device 500b is “far” without specific distance information. Additionally, the second finding user interface 631 includes a visual indication 633b indicating the first electronic device 500a has found the finding signal but has not receiving any distance and/or directional information from the second electronic device 500b. In some embodiments, the visual indication 633b is animated and moves around the second user interface 631.

In some embodiments, the first electronic device 500a receives an input (e.g., with contact 636) directed towards selectable option 628 on the second finding user interface 631 shown in FIG. 6E. In response to receiving the input, the first electronic device 500a ceases displaying the second finding user interface 631 and begins displaying the home screen user interface 600 shown in FIG. 6A, the control user interface 614 shown in FIG. 6B, or the user interface 622 shown in FIG. 6C. In some embodiments, in response to receiving the input, the first electronic device 500a ends the finding process.

In some embodiments, while in the finding state where the first electronic device 500a receives a finding signal without distance information, the first electronic device 500a moves (e.g., closer to the second electronic device 500b), as shown in the top-down environment 612 in FIG. 6F. In response to the movement, the first electronic device 500a receives a stronger finding signal and transitions to a finding state with low accuracy distance information (e.g., distance to the second electronic device 500b) and no directional information. As a result, as shown in FIG. 6F, the first electronic device 500a ceases to display the second finding user interface 631 and begins displaying a third finding user interface 638. As shown in FIG. 6F, the first electronic device 500a generates an alert 640 in response to transitioning user interfaces. In some embodiments, the alert 640 is the same as the alert 634. In some embodiments, the alert 640 is different than the alert 634 (e.g., in tempo, vibrations, pitch, amplitude, and/or pattern, as described in method 700).

FIG. 6F illustrates the third finding user interface 638. In some embodiments, the third finding user interface 638 is associated with the finding state with a low accuracy distance to the second electronic device 500b. The third finding user interface 638 includes visual indications 639a and 639b to illustrate the finding state and the low accuracy distance information. For example, as shown in FIG. 6F, the first electronic device 500a displays “40 ft” indicating the current distance to the second electronic device 500b. The first electronic device 500a also displays visual indication 639b indicating that the first electronic device 500a does not have directional information.

In some embodiments, the first electronic device 500a moves locations, as shown in the top-down environment 612 in FIG. 6G (e.g., closer to the second electronic device 500b). In response to the movement of the first electronic device 500a, the first electronic device 500a receives a stronger finding signal. As a result, the finding process changes states from a finding state with low accuracy distance information to a finding state with high accuracy distance information and directional information, which is described in further detail in method 700. In response to the change in state, the first electronic device 500a ceases to display the third finding user interface 638 associated with the finding state with low accuracy distance information and begins displaying a fourth finding user interface 642, shown in FIG. 6G. Additionally, in response to transitioning finding signal states (and user interfaces), the first electronic device 500a generates an alert 644, described in further detail in method 700. In some embodiments, the alert 644 includes tactile, audio, and/or visual feedback indicating that the finding process has transitioned finding states. In some embodiments, the alert 644 is different than the locating alert 632 generated at the second electronic device 500b, the alert 634, and the alert 640 discussed above. In some embodiments, the alert 634, the alert 640, and the alert 644 include the same feedback (e.g., are the same alert). For example, the alert 634, the alert 640, and the alert 644 includes a discrete haptic feedback, as described in method 700.

FIG. 6G illustrates the fourth finding user interface 642. In some embodiments, the first electronic device 500a displays the fourth finding user interface 642 when in a finding state with high accuracy distance information and directional information. In some embodiments, the first electronic device 500a displays the distance and directional information on the fourth finding user interface 642 using visual indications 643a and 643b. In FIG. 6G, the visual indication 643a indicates the current distance (“30 ft”) to the second electronic device 500b from the location of the first electronic device 500a. The visual indication 643b is optionally an arc that illustrates the direction of the second electronic device 500b relative to the first electronic device 500a. In some embodiments, the visual indications 643a and 643b are updated as the first electronic device 500a moves.

In FIG. 6G, while displaying the fourth finding user interface 642, the first electronic device 500a detects an input directed towards selectable option 630 (e.g., a tap of contact 646 on the first display generation component 504a). In some embodiments, in response to detecting the input directed towards selectable option 630 in FIG. 6G using contact 646, the first electronic device 500a transmits a request to the second electronic device 500b to generate the locating alert 632, as described above with reference to FIG. 6D and in method 700. FIG. 6H illustrates the second electronic device 500b generating the locating alert 632 in response to receiving the request to generate the locating alert 632. Additionally, in FIG. 6H, the first electronic device 500a has moved closer to the second electronic device 500b, as shown in the top-down environment 612. In response to the change in distance between the first electronic device 500a and the second electronic device 500b, the first electronic device 500a optionally updates visual indication 643a with the updated distance (e.g., “20 ft”).

FIG. 6H illustrates an additional or alternative embodiment of the fourth finding user interface 642. In some embodiments, the directional information regarding the second electronic device 500b is represented using visual indication 643c, an arrow, instead of visual indication 643b, an arc. In some embodiments, the directional information is more precise, therefore the first electronic device 500a displays visual indication 643c instead of visual indication 643b. In some embodiments, the visual indication 643b transitions to the visual indication 643c when the directional information is more precise.

In some embodiments, while the first electronic device 500a is in the location shown in FIG. 6H, a user moves the first electronic device 500a during the finding process, as similarly discussed above. FIG. 6I illustrates the updated location of the first electronic device 500a in the top-down environment 612. In FIG. 6I, the first electronic device 500a is moved to be closer to and to the right of the second electronic device 500b. As a result, the first electronic device 500a updates the fourth finding user interface 642 with the updated directional and distance information. In FIG. 6I, the first electronic device 500a updates visual indication 643a to indicate the updated distance between the first electronic device 500a and the second electronic device 500b (e.g., “10 ft”). The first electronic device 500a also updates visual indication 643b to illustrate that the second electronic device 500b is directly to the left of the first electronic device 500a.

In some embodiments, the user of the first electronic device 500a and/or the second electronic device 500b moves the first electronic device 500a within the threshold distance 610, as shown in FIG. 6J, which causes the first electronic device 500a to detect that it has entered the threshold distance of the second electronic device 500b. In response to detecting that the first electronic device 500a has entered the threshold distance 610, the first electronic device 500a displays a fifth finding user interface 648, as shown in FIG. 6J. While in the threshold distance, the finding signal optionally no longer has accurate directional information. As a result, the fifth finding user interface 648 optionally only shows distance information. The distance information is shown in visual indication 649a (“5 ft”) in FIG. 6J. In some embodiments, first electronic device 500a displays visual indication 649b to indicate that the first electronic device 500a is within the threshold distance 610 of the second electronic device 500b. Additionally, when displaying the fifth finding user interface 648, the first electronic device 500a generates alert 652. In some embodiments, the alert 652 is different than the alert 634, the alert 640, the alert 644, and the locating alert 632 discussed above. In some embodiments, the alert 652 includes a continuous haptic feedback, as described in further detail in method 700.

In some embodiments, in response to entering the threshold distance 610, the first electronic device 500a automatically transmits a request to the second electronic device 500b to generate alert 650, as shown in the top-down environment 612 in FIG. 6J and as described in further detail in method 700. In some embodiments, the alert 650 is different than the alert 634, the alert 640, the alert 644, the alert 652, and the locating alert 632. In some embodiments, the alert 650 has a different pitch, length, amplitude, vibration, and/or volume than the other alerts. Additional details regarding the alert 650 are provided in method 700.

In some embodiments, while in the threshold distance 610, the first electronic device 500a loses the high accuracy distance information from the finding signal. As a result, the first electronic device 500a does not display a specific distance in the fifth finding user interface 648. For example, as shown in FIG. 6K, visual indication 649a indicates that the distance to the second electronic device 500b is “close”. In some embodiments, the first electronic device 500a loses high accuracy distance information at a different threshold distance (e.g., threshold distance 655) than the threshold distance 610 discussed above. In some embodiments, the threshold distance 655, as shown in FIG. 6K is closer than the threshold distance 610 needed to generate the alert 650. The threshold distances needed to generate the alert 650 and to update the user interface with non-directional and/or non-specific distance information are described in further detail in method 700.

In some embodiments, the first electronic device 500a displays a sixth finding user interface 654, as shown in FIG. 6L, in response to the second electronic device 500b being found (e.g., by a user). In some embodiments, the first electronic device 500a detects that the distance between the second electronic device 500b is within a smaller threshold distance than threshold distance 610 and/or threshold distance 655. In some embodiments, as shown in FIG. 6L, the first electronic device 500a and/or the second electronic device 500b detect movement of the second electronic device 500b indicating that the second electronic device 500b is found. For example, a hand 658 of a user picks up the second electronic device 500b. As a result, the finding process is optionally ended.

FIG. 6L illustrates the sixth finding user interface 654 on the first electronic device 500a. In some embodiments, the first electronic device 500a displays the sixth finding user interface 654 in response to the second electronic device 500b being found and the finding process being ended. The sixth finding user interface 654 includes a visual indication 656 indicating that the second electronic device 500b has been found and that the finding process has concluded. In some embodiments, when the finding process ends, the visual, audio, and/or tactile feedback associated with the finding process is no longer generated by the first electronic device 500a and the second electronic device 500b, as described in method 700.

FIG. 6M illustrates an embodiment during the finding process in which the first electronic device 500a is above or below the second electronic device 500b (e.g., on a different floor of a building). For example, the first electronic device 500a enters the threshold distance 610, which causes the second electronic device 500b to generate alert 650. However, in some embodiments, the first electronic device 500a detects that the audio generated from alert 650 is above or below the first electronic device 500a (e.g., based on a volume of the audio). In other embodiments, the first electronic device 500a detects that the wireless signal (e.g., ultra-bandwidth signal), as described in method 700, is being transmitted by the second electronic device 500b from above or below the first electronic device 500a. As a result, the first electronic device 500a determines that the second electronic device 500b is above or below the first electronic device 500a and displays visual indication 660 on the fourth finding user interface 642, shown in FIG. 6M. In some embodiments, the visual indication 660 indicates that the user of the first electronic device 500a and/or the second electronic device 500b should check a different floor of the building to locate the second electronic device 500b. In some embodiments, because the first electronic device 500a had determined that the second electronic device 500b is not near the first electronic device 500a, the first electronic device does not display the fifth finding user interface 648 (which is normally displayed while in the threshold distance 610).

FIGS. 6N-6O illustrates embodiments in which the first electronic device 500a initiates the finding process while it is unavailable. For example, in response to receiving an input directed towards selectable option 618b in FIG. 6B, the first electronic device 500a displays visual indication 664, as shown in FIG. 6N, to indicate that the finding process is unavailable. In some embodiments, the finding process is unavailable because the first electronic device 500a and/or the second electronic device 500b are in an unsupported location, are in a low power mode, and/or are in a low connectivity mode, as described in method 700. In FIG. 6N, the first electronic device 500a is in a low power mode, as shown by a low power indicator 662 in the control user interface 614. In response to receiving an input directed towards the selectable option 618b in FIG. 6B and while the finding process is unavailable, the second electronic device 500b generates alert 632, shown in FIG. 6N. In some embodiments, while the finding process is unavailable, the first electronic device 500a is unable to receive directional and/or distance information. However, while the finding process is unavailable, the first electronic device 500a is still able to transmit a request to the second electronic device 500b to generate alert 632.

In a different example, in response to receiving an input directed towards selectable option 624b on user interface 622 in FIG. 6C, the first electronic device 500a displays user interface 666, as shown in FIG. 6O, different than the finding user interfaces discussed above, when the finding process is unavailable. Additionally, in response to receiving an input directed towards selectable option 624b, the first electronic device 500a transmits a request for the second electronic device 500b to generate the alert 632. In some embodiments, the second electronic device 500b will continue to generate the alert 632 (e.g., multiple times), until an input is received on selectable option 668 for ceasing generation of the alert 632 on the second electronic device 500b, as shown in FIG. 6O. As described above, and in method 700, while the finding process is unavailable, the first electronic device 500a is unable to receive directional and/or distance information.

FIG. 7 is a flow diagram illustrating a method in which a first electronic device and a second electronic device interact with each other during a finding process in accordance with some embodiments of the disclosure. The method 700 is optionally performed at first electronic device and/or electronic devices such as device 100, device 300, or device 500 as described above with reference to FIGS. 1A-1B, 2-3, 4A-4B and 5A-5C. Some operations in method 700 are, optionally combined and/or order of some operations is, optionally, changed.

As described below, the method 700 provides ways in which a first electronic device and a second electronic device interact during a finding process. Automatically generating an alert on the findable device when the first electronic device and the second electronic device are within a threshold distance from each other allows a user of the finding device and/or the findable device to efficiently locate the findable device, thus reducing the length of the locating process and saving power and/or other computing resources of the first and/or second electronic devices.

In some embodiments, method 700 is performed at a first electronic device (e.g., a finding device such as a smart watch or a smart phone, or a findable device) in communication with a second electronic device (e.g., a findable device, as described below, or a finding device), and wireless communication circuitry (and optionally one or more input devices). For example, the first electronic device and/or the second electronic device is a mobile device (e.g., a tablet, a smartphone, a media player, or a wearable device) including wireless communication circuitry, optionally in communication with one or more of a mouse (e.g., external), trackpad (optionally integrated or external), touchpad (optionally integrated or external), remote control device (e.g., external), another mobile device (e.g., separate from the electronic device), a handheld device (e.g., external), and/or a controller (e.g., external), etc.). In some embodiments, the first electronic device is in communication with a display generation component. The display generation component is optionally a display integrated with the electronic device (optionally a touch screen display), external display such as a monitor, projector, television, or a hardware component (optionally integrated or external) for projecting a user interface or causing a user interface to be visible to one or more users, etc. In some embodiments, the first electronic device is the finding device, and the second electronic device is the findable device, or vice versa. In some embodiments, the first electronic device and the second electronic device share a user account (e.g., a user account associated with a first user). For example, the user is logged into the user account on the first electronic device and the second electronic device. In some embodiments, the findable device is a dedicated remote locator object that is able to be attached to a physical item to track the location of the physical item. In some embodiments, a respective remote locator object is a device with a battery, one or more wireless antenna and/or a processor that enables the device to function as a remote locator object when associated with another physical object associated with the user other than the user of the electronic device (e.g., wallet, purse, backpack, suitcase, car, or a set of keys). In some embodiments, the findable device is configured to transmit location data of the first findable item to the finding device (e.g., wirelessly, such as over Bluetooth, RF, IR, NFC, or Wi-Fi) and vice versa. In some embodiments, the findable device has one or more components that can generate visual, tactile, and/or audible alerts, such as light-emitting elements, vibration elements, and/or speakers. In some embodiments, the findable device is associated with a name or label that is identifiable on an electronic device (e.g., the finding device such as the first electronic device and/or an electronic device of the user associated with (e.g., owning) the findable device (e.g., a third electronic device)). In some embodiments, the findable device is a device that has remote locator object functionalities built-in in addition to non-location tracking functionalities, such as headphones, a bicycle, a watch or a tablet.

In some embodiments, the first electronic device, such as first electronic device 500a in FIG. 6A, and the second electronic device, such as second electronic device 500b in FIG. 6A, are operating as part of a finding process (702a). In some embodiments, operating as part of the finding process includes using an electronic device to initiate the finding process (e.g., the finding device) to locate a different electronic device (e.g., the findable device). For example, the first electronic device initiates a process to locate the second electronic device. In some embodiments, the second electronic device initiates the process to locate the first electronic device. In some embodiments, during the finding process, there cannot be two finding devices or two findable devices (e.g., there is only one finding device and one or more findable devices that are part of the finding process). In some embodiments, initiating the process to locate the second electronic device includes receiving an input on a first user interface of the first electronic device to initiate the finding process (e.g., and/or vice versa). For example, the finding device displays a finding user interface in response to receiving the first input. In some embodiments, the first input includes a click, push, press, or swipe, detected, for example, via a touch-sensitive surface, a stylus, a keyboard or a mouse. In some embodiments, the first input is a tap, such as with a finger, of a widget corresponding to the item locating application in the first user interface. Alternatively, in some embodiments, the first input is a tap of a selectable option in the item locating application to locate a device such as the second electronic device or the first electronic device. In some embodiments, the input is directed towards a widget on the system user interface which transmits the request to access the location of the second electronic device to the first electronic device (e.g., or transmits the request to access the location of the first electronic device to the second electronic device). In some embodiments, in response to selecting the widget to initiate the finding process, the finding electronic device displays the finding user interface. Alternatively, the input is directed towards a selectable input on the first user interface in the item locating application. In some embodiments, the findable device and the finding device both actively transmit and/or receive wireless information to help the finding device accurately and efficiently locate the findable device.

In some embodiments, while the first electronic device and the second electronic device are operating as a part of a finding process, the first electronic device detects (702b) that a distance between a findable electronic device that is being located as part of the finding process, such as the second electronic device 500b, and a finding electronic device that is being used to locate the findable electronic device, such as the first electronic device 500a, as part of the finding process has changed. For example, the finding device (e.g., the first electronic device) moves relative to (e.g., closer to or farther from) the findable device (e.g., the second electronic device). In some embodiments, the change in distance is caused by a movement of a user of the finding device. For example, the user is holding and/or wearing the finding device. In some embodiments, the change in distance is due to movement of the findable device. In some embodiments, the change in distance is due to movement of the finding device and the findable device.

In some embodiments, in response to detecting that the distance between the findable electronic device and the finding electronic device has changed (702c), in accordance with a determination that one or more first criteria are satisfied, including a criterion that is satisfied when the findable electronic device and the finding electronic device are within a threshold distance (e.g., 0.01 m, 0.1 m, 0.5 m, 1 m, 2 m, 5 m, or 10 m) of each other in response to the change in distance (702d), the first electronic device causes (702e) the findable electronic device (e.g., the findable device, such as the first electronic device or the second electronic device) that is being located as part of the finding process to generate an alert, such as alert 650 shown in FIG. 6J, indicating that the finding electronic device is within the threshold distance of the findable electronic device, such as the threshold distance 610 indicated in FIG. 6J. In some embodiments, the findable device generates a locating sound, different from the alert, in response to receiving the request to initiate the finding process, as described above, and irrespective of whether the one or more first criteria are satisfied. For example, in response to receiving the request, the findable device first generates the locating sound, and in accordance with the determination that the one or more first criteria are satisfied, generates the alert (e.g., after and in addition to generating the locating sound). In some embodiments, the locating sound and/or the alert include visual, audio, and/or haptic or tactile feedback. In some embodiments, the locating sound includes different feedback than the alert. For example, generating the locating sound includes emitting a sound (e.g., a chime, ring, tune, or other audible feedback) that is different from a sound emitted when generating the alert. For example, the locating sound has a different frequency, period, wavelength, and/or pitch than the alert. In some embodiments, the first electronic device and the second electronic device are within a threshold distance of each other in a vertical direction (e.g., the first electronic device is located above or below the second electronic device) and/or in a horizontal direction (e.g., the first electronic device is located to the right of, to the left of, in front of, or behind the second electronic device). In some embodiments, the one or more first criteria also includes a criterion that is satisfied when the first electronic device and the second electronic device have been within a threshold distance of each other for less than a threshold amount of time (e.g., 1 second, 6 seconds, 10 seconds, 1 minute, or 30 minutes). For example, the findable device (the electronic device that is being located) generates the alert when the electronic devices go from being further than the threshold distance to closer than the threshold distance. The alert is optionally not continually generated when the electronic devices remain within the threshold distance of each other. In some embodiments, the alert is generated automatically in response to detecting that the first and second electronic devices are within the threshold distance of each other (e.g., without the first electronic device or the second electronic device detecting input to generate the alert).

In some embodiments, in accordance with a determination that the one or more first criteria are not satisfied (702f), the first electronic device forgoes (702g) causing the findable electronic device that is being located as part of the finding process to generate the alert indicating that the finding electronic device is within the threshold distance of the findable electronic device, such as when the first electronic device 500a is outside the threshold distance 610 and the second electronic device 500b does not generate the alert 650 as shown in FIGS. 6D-6I. In some embodiments, while the electronic devices are further than the threshold distance apart, the findable device does not generate the alert as part of the finding process. In some embodiments, while the one or more first criteria are not satisfied, the findable device still generates the locating sound, which is described previously above. In some embodiments, the finding device is configured to manually initiate generation of the locating sound on the findable device regardless of whether the one or more first criteria are satisfied (e.g., in response to detecting one of the inputs described above). Automatically generating an alert on the findable device when the first electronic device and the second electronic device are within a threshold distance from each other allows a user of the finding device and/or the findable device to efficiently locate the findable device, thus reducing the length of the locating process and saving power and/or other computing resources of the first and/or second electronic devices.

In some embodiments, the first electronic device is the findable electronic device (e.g., second electronic device 500b), and the second electronic device is the finding electronic device (e.g., first electronic device 500a). In some embodiments, the findable electronic device has one or more characteristics of the findable electronic device as described above. In some embodiments, the finding electronic device has one or more characteristics of the finding electronic device as described above. Automatically generating an alert on the findable device when the first electronic device and the second electronic device are within a threshold distance from each other allows a user of the finding device and/or the findable device to efficiently locate the findable device, thus reducing the length of the locating process and saving power and/or other computing resources of the first and/or second electronic devices.

In some embodiments, the first electronic device is the finding electronic device (e.g., first electronic device 500a) and the second electronic device is the findable electronic device (e.g., second electronic device 500b). In some embodiments, the finding electronic device has one or more characteristics of the finding electronic device as described above. In some embodiments, the findable electronic device has one or more characteristics of the findable electronic device as described above. Automatically causing the findable device to generate an alert using the finding electronic device when the first electronic device and the second electronic device are within a threshold distance from each other allows a user of the finding device and/or the findable device to efficiently locate the findable device, thus reducing the length of the locating process and saving power and/or other computing resources of the first and/or second electronic devices.

In some embodiments, the findable electronic device is a companion device of the finding electronic device, such as the second electronic device 500b being a companion device (phone) of the first electronic device 500a, shown in FIG. 6A. In some embodiments, a companion device includes any electronic device as described above, such as a phone, tablet, watch, or other electronic device, that is associated with the finding electronic device. In some embodiments, a companion device is a device that is communicatively connected to the finding electronic device. For example, the findable electronic device optionally shares a user account with the finding electronic device, is wirelessly connected (e.g., via Bluetooth, NFC, WiFi, or other wireless connections) to the finding electronic device. In some embodiments, the companion device shares functionalities with a host device (e.g., the findable electronic device). For example, in response to receiving a call, both the host device and the companion device receives an indication of a call, and the call is able to be answered on either device. In another example, a companion device includes a camera application in communication with a camera application of the host device. The camera application of the companion device is used to take pictures/videos on the camera application of the host device (e.g., by using the optical sensors on the host device). Allowing an electronic device to find a related electronic device (companion device) allows a user to effectively locate the findable electronic device thus reducing the length of the locating process and saving power and/or other computing resources of the first and/or second electronic devices.

In some embodiments, the findable electronic device is a remote locator device associated with the finding electronic device, such as if the first electronic device 500a in FIG. 6A is a remote locator device. In some embodiments, the remote locator device has one or more characteristics of the remote locator object as described above. In some embodiments, the remote locator device only operates as the findable electronic device. Alternatively, in some embodiments, the remote locator device is configured to operate as the findable electronic device or the finding electronic device. Using a remote locator device allows a user to locate any object that otherwise cannot be located, such as personal belongings, therefore reducing the length of the locating process.

In some embodiments, the finding process includes in accordance with a determination that (e.g., in response to detecting that) one or more second criteria are satisfied, causing the finding electronic device to generate a second alert (optionally different from the alert generated by the findable electronic device indicating that the finding electronic device is within the threshold distance of the findable electronic device), such as the first electronic device 500a displaying the plurality of finding user interfaces (e.g., fourth finding user interface 642), and tactile feedback (e.g., alert 634, 640, 644, and 652) shown in FIGS. 6D-6L.

In some embodiments, the one or more second criteria are satisfied in response to detecting that the distance between the findable electronic device and the finding electronic device has changed. For example, the findable electronic device and the finding electronic device are further apart from or closer to each other. In some embodiments, as described below, the second alert includes tactile feedback, audio feedback, and/or visual feedback. In some embodiments, the second alert is generated concurrently with the alert. In some embodiments, the second alert is generated without generating the alert discussed above. In some embodiments, second criteria includes a criterion that is satisfied when the finding electronic device changes finding states, as described below. Generating an alert at the finding electronic device allows a user of the finding electronic device to effectively locate the findable device, thus reducing the length of the locating process and saving power and/or other computing resources of the first and/or second electronic devices.

In some embodiments, generating the second alert includes generating tactile feedback at the finding electronic device, such as alert 634 shown in FIG. 6E or alert 652 shown in FIG. 6J. In some embodiments, the tactile feedback of the second alert is different than the tactile feedback of the alert discussed above. For example, the tactile feedback of the second alert have a different frequency, speed, and/or tempo from the tactile feedback of the alert generated when the finding electronic device and the findable electronic device are within the threshold distance from each other. In some embodiments, the tactile feedback of the second alert is synchronized to a tactile alert of the alert (e.g., their respective tactile feedback have one or more of the same qualities (e.g., frequency, speed, and/or tempo) and/or are generated concurrently). Providing tactile feedback at the finding electronic device allows the user to physically interact with the finding process, therefore allowing the user to efficiently locate the findable device, and/or provides a physical indication of a current progress of the finding process, thereby improving user-device interaction.

In some embodiments, the one or more second criteria include a criterion that is satisfied when the finding electronic device changes finding states (e.g., no finding signal state, finding signal with no distance to findable device state, finding signal with low accuracy distance to findable device state, finding signal with high accuracy distance to findable device state, and finding signal with a close proximity to findable device state), such as changing from the first finding user interface 626 representing the no finding signal state in FIG. 6D to the second finding user interface 631 representing the finding signal with no distance to findable device state in FIG. 6E. In some embodiments, the finding signal with a close proximity to findable device state is the state where the finding electronic device and the findable electronic device are within the threshold distance of each other.

In some embodiments, generating the second alert includes in accordance with a determination that the finding electronic device changes from a first finding state to a second finding state, generating first discrete tactile feedback (e.g., a tactile feedback that has a finite start and end, as described below), such as the first electronic device 500a generating alert 634 in response to changing from the first finding user interface 626 to the second finding user interface 631 (and the change in state), shown in FIG. 6E. In some embodiments, the first finding state is any of the finding states described above. In some embodiments, the second finding state is a finding state different than the first finding state. In some embodiments, the first tactile feedback has one or more characteristics of the tactile feedback of the second alert as described above.

In some embodiments, generating the second alert includes in accordance with a determination that the finding electronic device changes from the first finding state to a third finding state, different from the second finding state, generating second discrete tactile feedback, different from the first discrete tactile feedback (e.g., different frequency, speed, and/or tempo), such as the first electronic device 500a generating alert 640, different than alert 634, in response to changing from the first finding user interface 626 shown in FIG. 6D to the third finding user interface 638 (and the change in state), shown in FIG. 6F. In some embodiments, the second tactile feedback is the same as the first tactile feedback. In some embodiments, the first tactile feedback and the second tactile feedback are generated while the finding electronic device transitions between finding states (e.g., and not while in a particular finding state). In some embodiments, the first tactile feedback and the second tactile feedback are discrete (not continuous). In some embodiments, discrete tactile feedback is tactile feedback with a discrete start and end to the feedback. For example, discrete tactile feedback starts when the finding electronic device changes from the first finding state to the second finding state and ends after a specific amount of time (e.g., 1 second, 5 seconds, 10 seconds, or 30 seconds). In other examples, discrete tactile feedback starts when the finding electronic device detects movement of the finding electronic device (e.g., movement to transition between finding states), and ends when movement is no longer detected. Generating discrete tactile feedback while transitioning between finding states allows the user to track the transition between finding states without looking at the finding electronic device, therefore saving power and/or other computing resources of the finding electronic device and/or providing an indication of a current progress of the finding process.

In some embodiments, the one or more second criteria include a criterion that is satisfied when the finding electronic device is within the threshold distance of the findable electronic device (e.g., 0.01 m, 0.1 m, 0.5 m, 1 m, 2 m, 5 m, or 10 m, such as described above).

In some embodiments, in accordance with the determination that the one or more criteria is satisfied, the finding electronic device (e.g., the first electronic device 500a) generates the second alert includes generating a continuous tactile feedback (e.g., a tactile feedback that continues until some criteria is met, such as the findable device being found, the user turning the tactile feedback off, or the finding device moving more than a threshold distance away from the findable device), such as the first electronic device 500a generating alert 652 in FIG. 6J as a result of the first electronic device 500a entering the threshold distance 610. In some embodiments, while the finding electronic device and the findable electronic device are within the threshold distance of each other, the finding electronic device generates the continuous tactile feedback. Alternatively, in some embodiments, while the finding electronic device and the findable electronic device are within the threshold distance of each other, the findable electronic device generates a discrete tactile feedback. In some embodiments, the continuous tactile feedback is different than the first tactile feedback and/or the second tactile feedback, as described above. In some embodiments, the continuous tactile feedback has a different pattern, vibration, frequency, and/or tempo from the first tactile feedback and the second tactile feedback. In some embodiments, continuous tactile feedback is ongoing tactile feedback (e.g., even if the device isn't moving). For example, the continuous tactile feedback changes in frequency, pattern, tempo, and/or vibration as the device is moving but remains ongoing. In some embodiments, while the finding electronic device and the findable electronic device are within the threshold distance of each other, the continuous tactile feedback increases in frequency and/or amplitude as the distance between the finding electronic device and the findable electronic device decreases. In some embodiments, while the finding electronic device and the findable electronic device are within the threshold distance of each other, the continuous tactile feedback decreases in frequency and/or amplitude as the distance between the finding electronic device and the findable electronic device increases. Generating continuous tactile feedback while the finding electronic device is within the threshold distance of the findable electronic device allows the user to track the findable electronic device without looking at the finding electronic device, therefore saving power and/or other computing resources of the finding electronic device.

In some embodiments, the continuous tactile feedback is variable based on a distance from the finding electronic device to the findable electronic device, such as the tactile feedback for alert 652, shown in FIG. 6J, increasing in intensity as the distance between the first electronic device 500a and the second electronic device 500b decreases. In some embodiments, the continuous tactile feedback varies in intensity, vibration pattern, tempo, or frequency based on the distance from the finding electronic device to the findable electronic device. For example, the shorter the distance from the finding electronic device to the findable electronic device (e.g., within the threshold distance), the more intense the vibrations of the continuous tactile feedback (e.g., tactile feedback has a greater intensity when the time between subsequent tactile output decreases, when the frequency of the tactile output waveform increases or decreases, and/or when the amplitude of the tactile output increases). As another example, the shorter the distance from the finding electronic device to the findable electronic device (e.g., within the threshold distance), the greater the frequency of vibrations of the continuous tactile feedback. Generating continuous tactile feedback that is variable based on distance to the findable device allows the user to locate the findable electronic device without looking at the finding electronic device, therefore saving power and/or other computing resources of the finding electronic device.

In some embodiments, generating the second alert includes outputting audio feedback at the finding electronic device, such as if any of alerts 634, 640, 644, and 652 shown in FIGS. 6D-6L also includes audio feedback. In some embodiments, the second alert includes a combination of tactile and audio feedback. For example, the second alert includes generating tactile and audio feedback concurrently. In some embodiments, the audio feedback matches the patterns, pitch, intensity, and/or speed of the tactile feedback. For example, while the finding electronic device and the findable electronic device are within the threshold distance of each other, the tactile feedback increases in intensity of vibration and the audio feedback increases in volume. In some embodiments, the audio feedback is different than the tactile feedback. For example, the finding electronic device outputs the audio feedback over different intervals of the finding electronic device outputting the tactile feedback. Generating audio feedback while locating the findable electronic device allows the user to track the findable electronic device without looking at the finding electronic device, therefore saving power and/or other computing resources of the finding electronic device.

In some embodiments, generating the second alert includes displaying, via a display generation component of the finding electronic device, visual feedback, such as the visual feedback shown in the finding user interfaces in FIGS. 6D-6L (e.g., visual indication 649a on fifth finding user interface 648 shown in FIG. 6J). In some embodiments, the visual feedback is displayed on a finding user interface. In some embodiments, the finding user interface is associated with the finding process. In some embodiments, visual feedback includes directional information and/or nondirectional information, as described below. In some embodiments, visual feedback indicates a distance between the finding electronic device and the findable electronic device. In some embodiments, visual feedback is displayed concurrently while the finding electronic device generates audio feedback and/or tactile feedback as discussed above. Displaying visual feedback while locating the findable electronic device allows the user to track the findable electronic device efficiently and accurately, therefore saving power and/or other computing resources of the finding electronic device and the findable electronic device and/or provides a visual indication of a current progress of the finding process.

In some embodiments, the finding electronic device (e.g., first electronic device 500a) displays non-directional visual feedback while directional information associated with the findable electronic device that satisfies one or more respective criteria is not available to the finding electronic device. For example, the first electronic device 500a displays non-directional visual feedback using visual indications 639a-639b in FIG. 6F and using visual indications 649a-649b in FIG. 6K. In some embodiments, directional information that satisfies the one or more respective criteria includes directional information with sufficient strength and/or precision. In some embodiments, non-directional feedback includes information related to the distance between the finding electronic device and the findable electronic device without information related to the current location of the findable electronic device relative to the finding electronic device such as the direction of the findable electronic device relative to the finding electronic device. In some embodiments, the non-directional visual feedback is displayed while in the finding signal with no distance to findable device state, finding signal with low accuracy distance to findable device state, and/or while within the threshold distance of the findable electronic device. In some embodiments, while in the threshold distance, the finding electronic device displays visual feedback without a numerical indication of distance. For example, the finding electronic device may display “near” or “far” instead of a distance (e.g., in meters or feet). In some embodiments, the finding electronic device updates the indication of the distance in the non-directional visual feedback as the finding electronic device moves locations.

In some embodiments, in response to determining that one or more third criteria are satisfied, including a criterion that is satisfied when the finding electronic device obtains directional information associated with the findable electronic device (e.g., a high accuracy distance with the finding signal determined by the finding electronic device and/or provided by the findable electronic device) that satisfies the one or more respective criteria, the finding electronic device transitions to displaying directional visual feedback indicating a direction of the findable electronic device relative to the finding electronic device. For example, the first electronic device 500a displays directional information using visual indication 643b in FIG. 6G and visual indication 643c in FIG. 6H. In some embodiments, displaying directional visual feedback includes displaying an arc and/or an arrow indicating the relative location of the findable electronic device to the finding electronic device. In some embodiments, the directional visual feedback is updated as the finding electronic device moves locations relative to the findable electronic device. For example, if the findable electronic device is to the left of the finding electronic device (e.g., a wireless transmitter of the finding electronic device), then the arc and/or arrow is updated to indicate that the findable electronic device is to the left of the finding electronic device (e.g., the arc and/or arrow is displayed on a leftward region of the display generation component). Displaying non-directional visual feedback before receiving directional information while locating the findable electronic device allows the user to track the findable electronic device efficiently and accurately in accordance with a current finding state of the finding electronic device, therefore saving power and/or other computing resources of the finding electronic device and the findable electronic device.

In some embodiments, generating the second alert further includes displaying the directional visual feedback while the finding electronic device is outside of the threshold distance of the findable electronic device (e.g., and while receiving high accuracy distance information from the finding signal), such as with visual indication 643b in FIG. 6I. The directional visual feedback is described in greater detail above.

In some embodiments, in response to determining that one or more second criteria are satisfied, including a criterion that is satisfied when the finding electronic device is within a second threshold distance of the findable electronic device (e.g., the threshold distance and the one or more first criteria as described above or a second threshold distance that is smaller than the threshold distance as described above), the finding electronic device transitions to displaying non-directional visual feedback (e.g., in response to losing directional accuracy) indicating a distance of the findable electronic device relative to the finding electronic device, such as shown with visual indication 649b in FIG. 6J. In some embodiments, the second threshold distance is smaller than the threshold distance. For example, if the threshold distance to generate the alert at the findable electronic device is 5 feet, then the second threshold distance to transition to displaying the non-directional visual feedback on the finding electronic device is 2 feet. Alternatively, in some embodiments, while in the second threshold distance, the finding electronic device does not display an indication of the distance of the findable electronic device relative to the finding electronic device. In some embodiments, while in the second threshold distance, the finding electronic device is unable to receive information that includes an accurate distance of the findable electronic device from the finding electronic device. In some embodiments, non-directional visual feedback has one or more characteristics of the non-directional visual feedback as described above. In some embodiments, the non-directional visual feedback is different than the non-directional visual feedback as described above. For example, a different user interface is displayed. Displaying non-directional visual feedback while within a threshold distance of the findable electronic device while locating the findable electronic device allows the user to track the findable electronic device efficiently and accurately while receiving different information from the findable electronic device, therefore saving power and/or other computing resources of the finding electronic device and the findable electronic device and/or avoiding providing incorrect and/or inaccurate information to the user.

In some embodiments, in response to determining that the one or more second criteria are satisfied, transitioning to displaying the non-directional visual feedback at the finding electronic device occurs concurrently with the outputting of the alert at the findable electronic device in accordance with the determination that the one or more first criteria are satisfied. For example, in FIG. 6J, the first electronic device 500a transitions to displaying non-directional visual feedback as the second electronic device 500b generates alert 650. In some embodiments, the one or more first criteria is the same as the one or more second criteria (e.g., the first threshold distance and the second threshold distance are the same). In some embodiments, after (e.g., in response to) the one or more first criteria are satisfied, the finding electronic device displays the visual feedback (e.g., non-directional or directional) and the findable electronic device generates the alert (e.g., the alert generated by the findable electronic device in response to satisfaction of the one or more first criteria) at the same time. Alternatively, in some embodiments, the non-directional visual feedback is not displayed concurrently with the generation of the alert at the findable device. In some embodiments, only one of the types of feedback (e.g., audio, visual, and/or tactile) are generated in response to satisfying the one or more first criteria. Displaying non-directional visual feedback on the finding electronic device while outputting the audio alert on the findable electronic device concurrently allows the user to track the findable electronic device efficiently and accurately based on visual and audio cues while receiving different information from the findable electronic device and the finding electronic device, therefore saving power and/or other computing resources of the finding electronic device and the findable electronic device.

In some embodiments, the finding process includes, in accordance with a determination that one or more third criteria are satisfied indicating that the findable device has been retrieved, causing the finding electronic device to cease generating the second alert, such as concluding the finding process indicated by the display of sixth finding user interface 654 in FIG. 6L. In some embodiments, the one or more third criteria are described in further detail below. In some embodiments, causing the finding electronic device to cease generating the second alert includes causing the finding electronic device to cease generating audio, visual, and/or tactile feedback. In some embodiments, the finding electronic device stops generating the second alert when the findable electronic device is retrieved. In some embodiments, ceasing generating the second alert also includes ceasing displaying the finding user interface, as described herein. In some embodiments, ceasing generating the second alert signifies that the finding process has ended. Automatically ending the generation of the second alert on the finding electronic device after the findable electronic device has been found reduces the number of inputs on the finding electronic device to end the generation of the second alert thereby reducing erroneous inputs on the finding electronic device and saving power and/or other computing resources of the finding electronic device.

In some embodiments, the one or more third criteria include a criterion that is satisfied when the findable electronic device and the finding electronic device are within a second threshold distance (e.g., 1%, 5%, 10%, or 50% of the threshold distance), smaller than the threshold distance (e.g., the threshold distance as described above), of each other. For example, the first electronic device 500a and the second electronic device 500b are at a distance smaller than the threshold distance 610, shown in FIG. 6L, which causes the finding process to end. In some embodiments, in response to detecting that the finding electronic device is within the second threshold distance from the findable electronic device, the finding electronic device ceases generating the second alert and/or displaying the finding user interface as described herein. Automatically ending the generation of the second alert on the finding electronic device based on the proximity of the finding electronic device to the findable electronic device reduces the number of inputs on the finding electronic device to end the generation of the second alert thereby reducing erroneous inputs on the finding electronic device and saving power and/or other computing resources of the finding electronic device.

In some embodiments, the one or more third criteria include a criterion that is satisfied when the finding electronic device detects an indication of motion of the findable electronic device, such as hand 658 picking up the second electronic device 500b in FIG. 6L. In some embodiments, the findable electronic device includes one or more sensors (e.g., IMU sensor, GPS, accelerometer, and/or other sensors) that detects motion of the findable electronic device. In some embodiments, the one or more third criteria are satisfied when the motion is greater than a threshold motion. For example, the threshold is an acceleration greater than gravity or in a different direction than gravity. Alternatively, in some embodiments, the one or more third criteria are satisfied when the finding electronic device and/or the findable electronic device detects any motion of the findable electronic device. In some embodiments, in response to a user of the finding electronic device and/or findable electronic device moving (e.g., lifting and/or raising) the findable electronic device, the finding electronic device ceases to generate the second alert and/or the finding user interface. In some embodiments, the findable electronic device transmits sensor data to the finding electronic device indicating movement of the findable electronic device. Automatically ending the generation of the second alert on the finding electronic device based on the motion of the findable electronic device reduces the number of inputs on the finding electronic device to end the generation of the second alert thereby reducing erroneous inputs on the finding electronic device and saving power and/or other computing resources of the finding electronic device.

In some embodiments, after causing the findable electronic device to generate the alert when the findable electronic device and the finding electronic device are within the threshold distance of each other, in accordance with a determination that one or more second criteria are satisfied, the first electronic device causes the finding electronic device to generate a second alert indicating that the findable electronic device is located above or below the finding electronic device, such as shown with visual indication 660 in FIG. 6M. In some embodiments, the findable electronic device is located on a different floor of a building from the finding electronic device in the physical environment of the finding electronic device. For example, the finding electronic device is optionally within the threshold distance in a planar direction (e.g., left or right) but also a certain distance (e.g., 15, 20, 25, or 30 ft) away vertically (e.g., up or down) relative to the findable electronic device. In some embodiments, the second alert includes tactile, visual, and/or audio feedback. In some embodiments, the second alert is generated while displaying the finding user interface. In some embodiments the second alert includes displaying a visual alert on the finding user interface. In some embodiments, the visual alert indicates whether the findable electronic device is above or below the finding electronic device based on the one or more second criteria as described below. In some embodiments, the second alert is different than the alert generated by the findable electronic device in response to satisfaction of the one or more first criteria. In some embodiments, the one or more second criteria are described in greater detail below.

In some embodiments, after the first electronic device causes the findable electronic device to generate the alert when the findable electronic device and the finding electronic device are within the threshold distance of each other, in accordance with a determination that the one or more second criteria are not satisfied, the first electronic device forgoes causing the finding electronic device to generate the second alert, such as shown by the visual indication 660 not being present in FIG. 6J and FIG. 6K. Generating an alert on the finding electronic device indicating that the findable electronic device is on a different floor from the finding electronic device allows the finding electronic device to efficiently locate the findable device, thus reducing the length of the locating process and saving power and/or other computing resources of the first and/or second electronic devices.

In some embodiments, the one or more second criteria include a criterion that is satisfied based on a volume of the alert generated by the findable device that is detected by the finding device, such as if alert 650 shown in FIG. 6M is an audio alert. In some embodiments, the finding electronic device generates the second alert as a function of the volume of the alert from the findable electronic device (the alert generated by the findable electronic device in response to satisfaction of the one or more first criteria). For example, the findable electronic device generates the audio feedback of the alert at a constant volume, but the finding electronic device detects (e.g., using sensors such as a microphone) the audio feedback of the alert at different volumes based on the distance that the finding electronic device is away from the findable electronic device. Generating an alert on the finding electronic device indicating that the findable electronic device is on a different floor from the finding electronic device based on volume of the audio feedback allows the finding electronic device to efficiently locate the findable device, thus reducing the length of the locating process and saving power and/or other computing resources of the first and/or second electronic devices.

In some embodiments, the criterion is satisfied when the volume of the alert generated by the findable electronic device, detected by the finding electronic device, is less than a threshold volume (e.g., less than 10 dB, 30 dB, 40 dB, or 50 dB), such as if alert 650 shown in FIG. 6M is below the threshold volume. In some embodiments, if the finding electronic device is above or below the findable electronic device (e.g., on a different floor), the audio feedback of the alert would be detected as quieter (e.g., lower volume) than if the finding electronic device were on the same floor and within the threshold distance of the findable electronic device. In some embodiments, the finding electronic device includes directional sensing of audio. For example, the finding electronic device detects the alert and determines where the audio is coming from (e.g., whether the alert is being generated above or below the finding electronic device), and presents an indication accordingly (e.g., the findable device is on a floor above or on a floor below). Generating an alert on the finding electronic device indicating that the findable electronic device is on a different floor from the finding electronic device based on volume of the audio feedback allows the finding electronic device to efficiently locate the findable device, thus reducing the length of the locating process and saving power and/or other computing resources of the first and/or second electronic devices.

In some embodiments, the one or more second criteria include a criterion that is satisfied when a direction of a wireless signal (e.g., ultra-bandwidth (UWB) signal) transmitted from the findable electronic device is above or below the finding electronic device, such as if the wireless signal transmitted by the second electronic device 500b is above or below the first electronic device 500a in FIG. 6M. In some embodiments, UWB is a wireless protocol for communications using large frequency radio waves (e.g., between 6 GHz-9 GHz). In some embodiments, the finding electronic device and the findable electronic device use UWB signals for object tracking. For example, the devices are able to perform Time of Flight calculations to determine the distance and/or orientation between the devices. In some embodiments, in response to detecting that the finding electronic device and the findable electronic device are within the threshold distance discussed above of each other, the findable electronic device transmits the wireless signal that is detectable by the findable electronic device. In some embodiments, the wireless signal is transmitted and/or detected via the wireless communication circuitry discussed above. In some embodiments, if the finding electronic device detects that the direction from which the wireless signal is transmitted is above or below the current location of the finding electronic device, then the finding electronic device displays the second alert, as described above. In some embodiments, displaying the second alert includes display a visual indication of where the alert is being generated from (e.g., above or below the finding electronic device based on detecting that the direction of the wireless signal if coming from above or below the finding electronic device). Generating an alert on the finding electronic device indicating that the findable electronic device is on a different floor from the finding electronic device based on a direction of a wireless signal allows the finding electronic device to efficiently locate the findable device, thus reducing the length of the locating process and saving power and/or other computing resources of the first and/or second electronic devices.

In some embodiments, while the first electronic device and the second electronic device are operating as part of the finding process, the finding electronic device detects a request to locate the findable electronic device, such as if a user initiates the finding process by selecting selectable option 620 in FIG. 6B or selectable option 624b in FIG. 6C, or if a user requests to generate the locating alert 632 using selectable option 630 in FIG. 6G. For example, the finding electronic device receives an input (e.g., a tap input, swipe input, gaze input, or other input) indicating a request to locate the findable electronic device from a user of the finding electronic device and/or findable electronic device. In some embodiments, the request has one or more characteristics of the inputs described previously above.

In some embodiments, in response to detecting the request, the finding electronic device causes the findable electronic device to generate a second alert (e.g., having characteristics of the locating sound described above), different than the alert, such as locating alert 632 shown in FIG. 6D and in FIG. 6H. In some embodiments, the second alert is a manually generated alert. In some embodiments, the second alert has different audio, tactile, and/or visual feedback than the alert generated by the findable electronic device in response to satisfaction of the one or more first criteria. For example, the second alert is louder, longer, and/or has a different waveform than the alert. Manually generating an alert on the findable electronic device from the findable electronic device allows the findable electronic device to efficiently locate the findable device, thus reducing the length of the locating process and saving power and/or other computing resources of the first and/or second electronic devices.

In some embodiments, while the first electronic device and the second electronic device are operating as part of the finding process, the finding electronic device is displaying, in a finding user interface (e.g., having characteristics of the finding user interface as described above), an affordance for generating the second alert at the findable electronic device, such as selectable option 630 shown in FIG. 6G. In some embodiments, the affordance is an icon/button that is selectable to generate the second alert. In some embodiments, the finding user interface includes one or more selectable affordances that results in different actions on the finding electronic device and/or the findable electronic device. In some embodiments, the finding user interface also displays other feedback (e.g., directional feedback or non-directional feedback, described in greater detail above).

In some embodiments, detecting the request to locate the findable electronic device includes detecting, via one or more input devices of the findable electronic device, selection of the affordance in the finding user interface, such as with contact 646 in FIG. 6G. In some embodiments, the selection of the affordance includes detecting a user input, such as a click, push, press, or swipe, as described above. In some embodiments, as a result of the selection of the affordance, the finding electronic device generates the second alert. Displaying an affordance for generating the manual alert on the finding user interface reduces the number of inputs on the finding electronic device needed to generate the manual alert, thereby reducing erroneous inputs on the finding electronic device and saving power and/or other computing resources of the finding electronic device.

In some embodiments, the one or more first criteria include a criterion that is satisfied when the alert has not been previously generated within a threshold amount of time (e.g., within 1 second, 5 seconds, 10 seconds, 30 seconds, 1 minute, 2 minutes, 5 minutes, or 15 minutes). For example, if the first electronic device 500a exits and reenters the threshold distance 610 shown in FIG. 6J within the threshold amount of time, then the second electronic device 500b will not generate the alert 650. For example, the alert is generated when the finding electronic device and the findable electronic device are within the threshold distance. In some embodiments, if the finding electronic device and the findable electronic device are detected to be outside the threshold distance of each other, the alert is not generated again when the finding electronic device and the findable electronic device are detected to be within the threshold distance again before the threshold amount of time has elapsed. In some embodiments, the alert is not and/or is no longer generated after the threshold amount of time if the finding electronic device and the findable electronic device remain within the threshold distance of each other. In some embodiments, the alert is generated when the finding electronic device and the findable electronic device first enter the threshold distance and is not generated again until the finding electronic device and the findable electronic device re-enter the threshold distance after the threshold amount of time has elapsed. Suppressing the alert on the findable electronic device if the alert had been previously generated within a threshold amount of time reduces erroneous alerts on the findable electronic device, thereby saving power and/or other computing resources of the findable electronic device.

In some embodiments, while the first electronic device and the second electronic device are operating as part of the finding process, the first electronic device causes the findable electronic device to increase a strength of an output (e.g., a strength of a signal) of a wireless transmitter in communication with the findable electronic device, such as if the strength of output of the wireless transmitter increases in response to the initiation of the finding process as shown in FIG. 6B and FIG. 6C. In some embodiments, after the finding process is initiated, such as when the finding electronic device receives an input on a user interface, as described above, to initiate the finding processes, the findable electronic device increases the strength of output of the wireless transmitter. For example, the findable electronic device and the finding electronic device are communicating using WiFi, and in response to initiating the finding process, the finding electronic device and the findable electronic device begin communicating using UWB. In some embodiments, while not in the finding process (e.g., before it has started or after it has ended), the strength of output of the wireless transmitter is lower than while in the finding process. Increasing the power of the wireless transmitter on the findable electronic device when initiating the finding process increases the ability of the finding electronic device to effectively locate the findable electronic device, thus reducing the length of the locating process and saving power and/or other computing resources of the first and/or second electronic devices.

In some embodiments, operating as part of the finding process includes in accordance with a determination that one or more second criteria are satisfied, initiating the finding process between the first electronic device and the second electronic device in a second finding mode (e.g., locating sound only), such as shown by the second electronic device 500b only generating locating alert 632 in FIGS. 6N and 6O. In some embodiments, the finding electronic device receives an input to initiate the finding process. In some embodiments, the finding process is initiated in the first mode or the second mode in response to such an input and as a function of the one or more second criteria. In some embodiments, the one or more second criteria include a criterion as described below. In some embodiments, the second finding mode does not include displaying a finding user interface on the finding electronic device. In some embodiments, while in the second mode, the finding electronic device and the findable electronic device do not use UWB wireless transmission and/or finding signals. In some embodiments, initiating the second finding mode includes displaying an indication on the finding electronic device that the second finding mode is initiated. In some embodiments, while in the second finding mode, a user of the finding electronic device can transmit a request to locate the findable electronic device, and in response to receiving the request, the findable electronic device generates a locating alert, as described above.

In some embodiments, operating as part of the finding process includes in accordance with the determination that the one or more second criteria are not satisfied, initiating the finding process in a first finding mode (e.g., using the alert generated by the findable electronic device in response to satisfaction of the one or more first criteria), different from the second finding mode, such as the finding process illustrated with the finding user interfaces in FIGS. 6D-6M. In some embodiments, the first finding mode includes generating the alert at the findable electronic device and generating a second alert at the finding electronic device, which has one or more characteristics of the second alert described above. In some embodiments, the first finding mode includes displaying the finding user interface at the finding electronic device. In some embodiments, while in the first finding mode, the finding electronic device and the findable electronic device use UWB wireless transmission and/or finding signals. Automatically operating the finding process in different modes based on different criteria reduces the number of erroneous inputs on the finding electronic device to initiate and/or set up the finding process, thereby saving power and/or other computing resources of the first and/or second electronic devices.

In some embodiments, the one or more second criteria include a criterion that is satisfied when the first electronic device and/or the second electronic device are in a respective region in which operating as part of the finding process in the first finding mode is unsupported, such as if the first electronic device 500a and/or the second electronic device 500b were in an unsupported region in FIG. 6N or 6O. In some embodiments, certain regions (e.g., countries, cities, states, and the like) do not permit the use of finding signals. In some embodiments, in response to satisfying the one or more second criteria, the finding electronic device and the findable electronic device are in the second finding mode, as described above. In some embodiments, if the finding electronic device and the findable electronic device are no longer in the unsupported region (e.g., the devices move locations), then the finding process transitions from the second finding mode to the first finding mode. Automatically operating the finding process in different modes based a location of the first and/or second electronic device reduces the number of erroneous inputs on the finding electronic device to initiate and/or set up the finding process thereby saving power and/or other computing resources of the first and/or second electronic devices.

In some embodiments, the one or more second criteria include a criterion that is satisfied when the first electronic device or the second electronic device is operating in a low power mode, such as shown by the low power indicator 662 in FIG. 6N. In some embodiments, the low power mode is automatically initiated when the finding electronic device and/or the findable electronic device reaches 20% battery power. In some embodiments, a user initiates the low power mode on the finding electronic device and/or the findable electronic device. In some embodiments, in response to operating in the low power mode, the finding electronic device and the findable electronic device operate in the second finding mode. In some embodiments, if the finding electronic device and the findable electronic device are no longer in the low power mode (e.g., the devices are charging and/or a user turns off the low power mode), then the finding process transitions from the second finding mode to the first finding mode. Automatically operating the finding process in different modes based a low power mode of the first and/or second electronic device reduces the number of erroneous inputs on the finding electronic device to initiate and/or set up the finding process, thereby saving power and/or other computing resources of the first and/or second electronic devices.

In some embodiments, the one or more second criteria include a criterion that is satisfied when the first electronic device or the second electronic device is operating in a reduced connectivity mode, such as shown by selectable option 618a being unselected on the first electronic device 500a in FIG. 6N. For example, the finding electronic device and/or the findable electronic device are in an area with low connectivity (e.g., no cellular service) and/or have airplane mode on, then the finding electronic device and the findable electronic device operate in the second finding mode. In some embodiments, airplane mode is a mode on the finding electronic device and/or the findable electronic device where some or all wireless communications are turned off. In some embodiments, if the finding electronic device and/or the findable electronic device begin operating in a normal connectivity mode (e.g., airplane mode off), then the finding process transitions from the second finding mode to the first finding mode. Automatically operating the finding process in different modes based the connectivity of the first and/or second electronic device reduces the number of erroneous inputs on the finding electronic device to set up the finding process thereby saving power and/or other computing resources of the first and/or second electronic devices.

In some embodiments, while the first electronic device and the second electronic device are operating as part of the finding process, while the finding electronic device is displaying a finding user interface associated with the finding process, the first electronic device detects a transition of the finding electronic device from a high power state to a low power state, such as if a user turns off the display generation component 504a while the first electronic device 500a is displaying fourth finding user interface 642 in FIG. 6I. In some embodiments, the finding user interface has one or more characteristics of the finding user interface as described above. In some embodiments, a high power state is a state where the finding electronic device and/or the findable electronic device operate in which some device functions that use additional power are turned on. For example, while in the high power state, the findable electronic device and/or the finding electronic device can use higher-power UWB wireless transmission and finding signals. In some embodiments, the high power state occurs when the finding electronic device actively has the display generation component on. In some embodiments, the low power state has one or more characteristics of the low power mode as described above. In some embodiments, the low power state is a state where the finding electronic device and/or the findable electronic device reduce power usage. In some embodiments, while in the low power state, one or more components are not completely turned off; rather, they operate at a lower power usage state. For example, while in the low power state, the devices operate using low-power UWB wireless transmission and finding signals. In some embodiments, the low power state occurs when the finding electronic device is in a sleep mode (e.g., the display is off), or when the low power mode is on.

In some embodiments, in response to detecting the transition of the finding electronic device from the high power state to the low power state, the first electronic device causes the finding electronic device to cease display of the finding user interface while the finding electronic device is in the low power state, such as if the display generation component 504a is turned off in FIG. 6I. In some embodiments, the finding electronic device enters a sleep mode when transitioning from the high power state to the low power state. In some embodiments, while in the sleep mode, the display generation component of the finding electronic device is off or in a lower power state in which brightness is reduced and/or a display refresh rate is reduced relative to the high power state. In some embodiments, while in the low power state, the finding process is still active. For example, the finding electronic device and the findable electronic device are still communicating with respect to location and/or distance, but optionally at a reduced power level and/or reduced frequency. In some embodiments, while in the low power state, visual portions of alerts are not presented (because the display is off). Alternatively, while in the low power state, the finding process is no longer active. For example, the finding electronic device and the findable electronic device are no longer communicating location and/or distance to each other.

In some embodiments, while the finding electronic device is in the low power state, the first electronic device detects a respective event that causes the finding electronic device to transition from the low power state to the high power state, such as if the first electronic device 500a receives a tap input while the display generation component 504a is off in FIG. 6I. For example, the finding electronic device wakes from the sleep mode and enters the wake mode. In some embodiments, sleep mode is when the display of the electronic device is off (or in a lower brightness and/or has a lower refresh rate) and wake mode is when the display of the electronic device is on. In some embodiments, sleep mode is a low power state and wake mode is a high power state (where the display is on, has a higher brightness and/or has a higher refresh rate). In some embodiments, the event includes a tap on the display generation component (e.g., touchscreen), button press, a rotation of a mechanical component on the finding electronic device (e.g., a crown), or a physical movement of the finding electronic device (e.g., being lifted such as by a hand of the user or by a wrist raise).

In some embodiments, in response to detecting the respective event, the first electronic device causes the finding electronic device to operate in the high power state, including in accordance with a determination that the finding electronic device was in the first finding mode when it transitioned from the high power state to the low power state, causing the finding electronic device to redisplay the finding user interface in the high power state, such as redisplaying fourth user interface 642 in FIG. 6I. In some embodiments, if while in the low power state the finding process is still active, then in response to transitioning back to the high power state, the display is turned back on (e.g., has a higher brightness and/or has a higher refresh rate) and the finding user interface is presented. In some embodiments, in this embodiment, the finding electronic device resumes performing all actions of the finding process (e.g., display visual alerts). In some embodiments, while in the low power state, the finding process is no longer active. In such embodiments, while in the first finding mode, in response to transitioning back to the high power state, the finding electronic device and the findable electronic device resume searching using the higher power UWB wireless transmission and finding signal. In some embodiments, in response to redisplaying the finding user interface, the finding electronic device restarts the finding process.

In some embodiments, in accordance with a determination that the finding electronic device was in the second finding mode (e.g., having one or more characteristics of the second finding mode as described above) when it transitioned from the high power state to the low power state, such as if a user turns off the display generation component 504a while the low power indicator 662 was on (e.g., as shown in FIG. 6N), the first electronic device causes the finding electronic device to forgo redisplaying the finding user interface in the high power state, such as if the first electronic device 500a displays the control user interface 614 in FIG. 6B or the user interface 622 in FIG. 6C as a result of returning to the high power state while in the second finding mode. For example, if the finding electronic device wakes from the low power state (e.g., screen off or has a lower brightness and/or has a lower refresh rate) and the finding electronic device is in the second finding mode, then the finding electronic device does not redisplay the finding user interface. In some embodiments, while in the second finding mode, the finding electronic device ends the finding process in response to detecting the transition to the low power state or the transition back to the high power state. In some embodiments, the finding electronic device has to reinitiate the finding process. Automatically transitioning the finding electronic device from a low power state to a high power state based on the finding mode reduces the number of erroneous inputs on the finding electronic device to initiate and/or set up the finding process thereby saving power and/or other computing resources of the first and/or second electronic devices.

It should be understood that the particular order in which the operations in FIG. 7 have been described is merely exemplary and is not intended to indicate that the described order is the only order in which the operations could be performed. One of ordinary skill in the art would recognize various ways to reorder the operations described herein.

The operations in the information processing methods described above are, optionally, implemented by running one or more functional modules in an information processing apparatus such as general purpose processors (e.g., a as described with respect to FIGS. 1A-1B, 3, 5A-5J) or application specific chips. Further, the operations described above with reference to FIG. 7 are, optionally, implemented by components depicted in FIGS. 1A-1B. For example, detecting operation 702a, causing operation 702e and 702g are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology is tracking and displaying content. The present disclosure contemplates that in some instances, the data utilized may include personal information data that uniquely identifies or can be used to contact or locate a specific person. Such personal information data can include demographic data, content consumption activity, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, capturing and transmitting content can enable the user to view the content at a later time. Accordingly, use of such personal information data enables users to use electronic devices to view content. Further, other uses for personal information data that benefit the user are also contemplated by the present disclosure. For instance, personal information data may be used to track the location of various devices.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of location services, the present technology can be configured to allow users to select to “opt in” or “opt out” of participation in the collection of personal information data during registration for services or anytime thereafter. In another example, users can select not to enable recording of personal information data in a specific application (e.g., first application and/or second application). In addition to providing “opt in” and “opt out” options, the present disclosure contemplates providing notifications relating to the access or use of personal information. For instance, a user may be notified upon initiating content collection that their personal information data will be accessed and then reminded again just before personal information data is accessed by the device(s).

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an electronic device version tracks content without associating the content with personal user data.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method comprising:
at a first electronic device in communication with a second electronic device, and wireless communication circuitry:
while the first electronic device and the second electronic device are operating as part of a finding process:
detecting that a distance between a findable electronic device that is being located as part of the finding process and a finding electronic device that is being used to locate the findable electronic device as part of the finding process has changed; and
in response to detecting that the distance between the findable electronic device and the finding electronic device has changed:
in accordance with a determination that one or more first criteria are satisfied, including a criterion that is satisfied when the findable electronic device and the finding electronic device are within a threshold distance of each other in response to the change in distance, causing the findable electronic device that is being located as part of the finding process to generate an alert indicating that the finding electronic device is within the threshold distance of the findable electronic device; and
in accordance with a determination that the one or more first criteria are not satisfied, forgoing causing the findable electronic device that is being located as part of the finding process to generate the alert indicating that the finding electronic device is within the threshold distance of the findable electronic device.

2. The method of claim 1, wherein the first electronic device is the findable electronic device, and the second electronic device is the finding electronic device.

3. The method of claim 1, wherein the first electronic device is the finding electronic device, and the second electronic device is the findable electronic device.

4. The method of claim 1, wherein the findable electronic device is a companion device of the finding electronic device.

5. The method of claim 1, wherein the findable electronic device is a remote locator device associated with the finding electronic device.

6. The method of claim 1, wherein the finding process includes in accordance with a determination that one or more second criteria are satisfied, causing the finding electronic device to generate a second alert.

7. The method of claim 6, wherein generating the second alert includes generating tactile feedback at the finding electronic device.

8. The method of claim 7, wherein:
the one or more second criteria include a criterion that is satisfied when the finding electronic device changes finding states; and generating the second alert includes:
in accordance with a determination that the finding electronic device changes from a first finding state to a second finding state, generating first discrete tactile feedback; and
in accordance with a determination that the finding electronic device changes from the first finding state to a third finding state, different from the second finding state, generating second discrete tactile feedback, different from the first discrete tactile feedback.

9. The method of claim 7, wherein:
the one or more second criteria include a criterion that is satisfied when the finding electronic device is within the threshold distance of the findable electronic device; and
generating the second alert includes generating a continuous tactile feedback.

10. The method of claim 9, wherein the continuous tactile feedback is variable based on a distance from the finding electronic device to the findable electronic device.

11. The method of claim 6, wherein generating the second alert includes outputting audio feedback at the finding electronic device.

12. The method of claim 6, wherein generating the second alert includes displaying, via a display generation component of the finding electronic device, visual feedback.

13. The method of claim 12, wherein generating the second alert further includes:
displaying non-directional visual feedback while directional information associated with the findable electronic device that satisfies one or more respective criteria is not available to the finding electronic device; and
in response to determining that one or more third criteria are satisfied, including a criterion that is satisfied when the finding electronic device obtains the directional information associated with the findable electronic device that satisfies the one or more respective criteria, transitioning to displaying directional visual feedback indicating a direction of the findable electronic device relative to the finding electronic device.

14. The method of claim 12, wherein generating the second alert further includes:
displaying directional visual feedback while the finding electronic device is outside of the threshold distance of the findable electronic device; and
in response to determining that one or more second criteria are satisfied, including a criterion that is satisfied when the finding electronic device is within a second threshold distance of the findable electronic device, transitioning to displaying non-directional visual feedback indicating a distance of the findable electronic device relative to the finding electronic device.

15. The method of claim 14, wherein:
in response to determining that the one or more second criteria are satisfied, transitioning to displaying the non-directional visual feedback at the finding electronic device occurs concurrently with an outputting of the alert at the findable electronic device in accordance with the determination that the one or more first criteria are satisfied.

16. The method of claim 6, wherein the finding process includes:
in accordance with a determination that one or more third criteria are satisfied indicating that the findable electronic device has been retrieved, causing the finding electronic device to cease generating the second alert.

17. The method of claim 16, wherein the one or more third criteria include a criterion that is satisfied when the findable electronic device and the finding electronic device are within a second threshold distance, smaller than the threshold distance, of each other.

18. The method of claim 16, wherein the one or more third criteria include a criterion that is satisfied when the finding electronic device detects an indication of motion of the findable electronic device.

19. The method of claim 1, further comprising:
after causing the findable electronic device to generate the alert when the findable electronic device and the finding electronic device are within the threshold distance of each other:
in accordance with a determination that one or more second criteria are satisfied, causing the finding electronic device to generate a second alert indicating that the findable electronic device is located above or below the finding electronic device;
and in accordance with a determination that the one or more second criteria are not satisfied, forgoing causing the finding electronic device to generate the second alert.

20. The method of claim 19, wherein the one or more second criteria include a criterion that is satisfied based on a volume of the alert generated by the findable electronic device that is detected by the finding electronic device.

21. The method of claim 20, wherein the criterion is satisfied when the volume of the alert generated by the findable electronic device, detected by the finding electronic device, is less than a threshold volume.

22. The method of claim 18, wherein the one or more second criteria include a criterion that is satisfied when a direction of a wireless signal transmitted from the findable electronic device is above or below the finding electronic device.

23. The method of claim 1, wherein, while the first electronic device and the second electronic device are operating as part of the finding process:
detecting a request to locate the findable electronic device from the finding electronic device; and
in response to detecting the request, causing the findable electronic device to generate a second alert, different than the alert.

24. The method of claim 23, wherein:
while the first electronic device and the second electronic device are operating as part of the finding process, the finding electronic device is displaying, in a finding user interface, an affordance for generating the second alert at the findable electronic device; and
detecting the request to locate the findable electronic device includes detecting, via one or more input devices of the findable electronic device, selection of the affordance in the finding user interface.

25. The method of claim 1, wherein the one or more first criteria include a criterion that is satisfied when the alert has not been previously generated within a threshold amount of time.

26. The method of claim 1, further comprising, while the first electronic device and the second electronic device are operating as part of the finding process:
causing the findable electronic device to increase a strength of an output of a wireless transmitter in communication with the findable electronic device.

27. The method of claim 1, wherein operating as part of the finding process includes:
in accordance with a determination that one or more second criteria are satisfied, initiating the finding process between the first electronic device and the second electronic device in a second finding mode; and
in accordance with the determination that the one or more second criteria are not satisfied, initiating the finding process in a first finding mode, different from the second finding mode.

28. The method of claim 27, wherein the one or more second criteria include a criterion that is satisfied when the first electronic device and/or the second electronic device are in a respective region in which operating as part of the finding process in the first finding mode is unsupported.

29. The method of claim 27, wherein the one or more second criteria include a criterion that is satisfied when the first electronic device or the second electronic device is operating in a low power mode.

30. The method of claim 27, wherein the one or more second criteria include a criterion that is satisfied when the first electronic device or the second electronic device is operating in a reduced connectivity mode.

31. The method of claim 27, further comprising:
while the first electronic device and the second electronic device are operating as part of the finding process:
while the finding electronic device is displaying a finding user interface associated with the finding process, detecting a transition of the finding electronic device from a high power state to a low power state;
in response to detecting the transition of the finding electronic device from the high power state to the low power state, causing the finding electronic device to cease display of the finding user interface while the finding electronic device is in the low power state while the finding electronic device is in the low power state, detecting a respective event that causes the finding electronic device to transition from the low power state to the high power state; and
in response to detecting the respective event, causing the finding electronic device to operate in the high power state, including:
in accordance with a determination that the finding electronic device was in the first finding mode when it transitioned from the high power state to the low power state, causing the finding electronic device to redisplay the finding user interface in the high power state; and
in accordance with a determination that the finding electronic device was in the second finding mode when it transitioned from the high power state to the low power state, forgoing causing the finding electronic device to redisplay the finding user interface in the high power state.

32. A first electronic device that is in communication with a display generation component and one or more input devices, the electronic device comprising:
one or more processors;
memory; and
one or more programs, wherein the one or more programs are stored in the memory and configured to be executed by the one or more processors, the one or more programs including instructions for:
detecting that a distance between a findable electronic device that is being located as part of a finding process and a finding electronic device that is being used to locate the findable electronic device as part of the finding process has changed; and
in response to detecting that the distance between the findable electronic device and the finding electronic device has changed:
in accordance with a determination that one or more first criteria are satisfied, including a criterion that is satisfied when the findable electronic device and the finding electronic device are within a threshold distance of each other in response to the change in distance, causing the findable electronic device that is being located as part of the finding process to generate an alert indicating that the finding electronic device is within the threshold distance of the findable electronic device; and
in accordance with a determination that the one or more first criteria are not satisfied, forgoing causing the findable electronic device that is being located as part of the finding process to generate the alert indicating that the finding electronic device is within the threshold distance of the findable electronic device.

33. A non-transitory computer readable storage medium storing one or more programs, the one or more programs comprising instructions, which when executed by one or more processors of a first electronic device, cause the first electronic device to perform a method comprising:
detecting that a distance between a findable electronic device that is being located as part of the finding process and a finding electronic device that is being used to locate the findable electronic device as part of the finding process has changed; and
in response to detecting that the distance between the findable electronic device and the finding electronic device has changed:
in accordance with a determination that one or more first criteria are satisfied, including a criterion that is satisfied when the findable electronic device and the finding electronic device are within a threshold distance of each other in response to the change in distance, causing the findable electronic device that is being located as part of the finding process to generate an alert indicating that the finding electronic device is within the threshold distance of the findable electronic device; and
in accordance with a determination that the one or more first criteria are not satisfied, forgoing causing the findable electronic device that is being located as part of the finding process to generate the alert indicating that the finding electronic device is within the threshold distance of the findable electronic device.
